(19) United States
(12) Patent Application Publication
(10) Pub. No.: US 2021/0142440 A1
(43) Pub. Date: May 13, 2021

(54) IMAGE CONVERSION APPARATUS AND METHOD, AND COMPUTER-READABLE RECORDING MEDIUM

(71) Applicant: HYPERCONNECT, INC., Seoul (KR)

(72) Inventors: Sangil Ahn, Cheongju-si (KR); Seokjun Seo, Seoul (KR); Hyountaek Yong, Seoul (KR); Sungjoo Ha, Seongnam-si (KR); Martin Kersner, Seoul (KR); Beomsu Kim, Seoul (KR); Dongyoung Kim, Incheon (KR)

(73) Assignee: HYPERCONNECT, INC., Seoul (KR)

(21) Appl. No.: 17/092,486

(22) Filed: Nov. 9, 2020

(30) Foreign Application Priority Data
Nov. 7, 2019 (KR) 10-2019-0141723
Dec. 30, 2019 (KR) 10-2019-0177946
Dec. 31, 2019 (KR) 10-2019-0179927
Feb. 25, 2020 (KR) 10-2020-0022795

(51) Int. Cl. G06T 3/00; G06K 9/00

(52) U.S. Cl. CPC G06T 3/00; G06K 9/00281

(57) ABSTRACT

An image conversion apparatus for converting an image by using an artificial neural network includes: an image receiver receiving an image from a user; a template obtainer obtaining at least one image conversion template; and an image converter converting the static image into a moving image by using the obtained at least one image conversion template, wherein the image converter converts the static image received by the image receiver, into the moving image.

### CROSS-REFERENCE TO RELATED APPLICATION

This application claims the benefit of Korean Patent Applications Nos. 10-2019-0141723, filed on Nov. 7, 2019, 10-2019-0177946, filed on Dec. 30, 2019, 10-2019-0179927, filed on Dec. 31, 2019, and 10-2020-0022795, filed on Feb. 25, 2020 in the Korean Intellectual Property Office, the disclosure of which is incorporated herein in its entirety by reference.

### TECHNICAL FIELD

The present disclosure relates to an image conversion apparatus and method, and a computer-readable recording medium, and more particularly, to an image conversion apparatus and method, in which a static image may be converted into a natural moving image, and a computer-readable recording medium.

The present disclosure relates a landmark data decomposition apparatus and method, and a computer-readable recording medium, and more particularly, to a landmark data decomposition apparatus and method, in which landmark data may be more accurately separated from a face included in an image, and a computer-readable recording medium.

The present disclosure relates to a landmark decomposition apparatus and method, and a computer-readable recording medium, and more particularly, to a landmark decomposition apparatus and method, in which a landmark may be decomposed from one frame or a small number of frames, and a computer-readable recording medium.

The present disclosure relates to an image transformation apparatus and method, and a computer-readable recording medium, and more particularly, to an image transformation apparatus and method, in which an image that is naturally transformed according to characteristics of another image may be generated, and a computer-readable recording medium.

### BACKGROUND ART

Most portable personal devices have built-in cameras and may thus capture static images or moving images such as videos. Whenever a moving image of a desired facial expression is needed, a user of a portable personal device has to use a built-in camera of the portable personal device to capture an image.

When the moving image of the desired facial expression is not obtained, the user has to repeatedly capture images until a satisfactory result is obtained. Accordingly, there is a need for a method of transforming a static image input by the user into a natural moving image by inserting a desired facial expression into the static image.

Research on techniques that analyze and use an image of a person's face based on facial landmarks obtained by extracting facial key points of the person's face is being actively conducted. The facial landmarks include result values of extracting points of major elements of a face, such as eyes, eyebrows, a nose, a mouth, and a jawline or extracting an outline drawn by connecting the points. The facial landmarks are mainly used in techniques such as facial expression classification, pose analysis, face synthesis, face transformation, etc.

However, facial image analysis and utilization techniques of the related art that are based on facial landmarks do not take into account appearance and emotional characteristics of the face when processing the facial landmarks, which results in a decrease in performance of the techniques. Therefore, in order to improve the performance of the facial image analysis and utilization techniques, there is a need for development of techniques for decomposing the facial landmarks including the emotional characteristics of the face.

### DESCRIPTION OF EMBODIMENTS

### Technical Problem

The present disclosure provides an image conversion apparatus and method, in which a static image may be converted into a natural moving image, and a computer readable recording medium.

The present disclosure provides a landmark data decomposition apparatus and method, in which landmark data may be more accurately and precisely decomposed from a face included in an image, and a computer-readable recording medium.

The present disclosure provides a landmark decomposition apparatus and method, in which landmark decomposition may be performed even on an object with only a small amount of data, and a computer-readable recording medium.

The present disclosure provides an image transformation apparatus and method, in which, when a target image is given as an object to be transformed, a user image different from the target image may be used to generate an image that conforms to the user image and also has characteristics of the target image, and a computer-readable recording medium.

### Solution to Problem

An image conversion method according to an embodiment of the present disclosure, which uses an artificial neural network, includes receiving a static image from a user, obtaining at least one image conversion template, and transforming the static image into a moving image by using the obtained image conversion template.

### Advantageous Effects of Disclosure

The present disclosure may provide an image conversion apparatus and method, in which, even though a user does not directly capture a moving image, a moving image having the same effect as a moving image captured by the user directly changing his or her facial expression is provided, and a computer-readable recording medium.

The present disclosure may provide an image conversion method and method, in which a moving image generated by converting a static image is provided to a user, to thereby provide the user with an interesting user experience along with the moving image, and a computer-readable recording medium.

The present disclosure may provide a landmark data decomposition apparatus and method, in which landmark data may be more accurately and precisely decomposed from a face included in an image, and a computer-readable recording medium.

The present disclosure may provide a landmark data decomposition apparatus and method, in which landmark data including information about characteristics and facial expressions of a face included in an image may be more accurately decomposed, and a computer-readable recording medium.

The present disclosure may provide a landmark decomposition apparatus and method, in which landmark decomposition may be performed even on an object with only a small amount of data, and a computer-readable recording medium.

The present disclosure may provide an image transformation apparatus and method, in which, when a target image is given as an object to be transformed, a user image different from the target image may be used to generate an image that conforms to the user image and also has characteristics of the target image, and a computer-readable recording medium.

### BRIEF DESCRIPTION OF DRAWINGS

FIG. 1 is a schematic view of an environment in which an image conversion method is performed, according to the present disclosure.

FIG. 2 is a schematic view of a configuration of an image conversion apparatus according to an embodiment of the present disclosure.

FIG. 3 is a schematic flowchart of an image conversion method according to an embodiment of the present disclosure.

FIG. 4 is a diagram illustrating an image conversion template according to an embodiment of the present disclosure.

FIG. 5A is a diagram illustrating a process of generating a moving image according to an embodiment of the present disclosure.

FIG. 5B is a diagram illustrating a moving image generated according to an embodiment of the present disclosure.

FIG. 6A is a diagram illustrating a process of generating a moving image according to another embodiment of the present disclosure.

FIG. 6B is a diagram illustrating a moving image generated according to another embodiment of the present disclosure.

FIG. 7 is a schematic view of a configuration of an image conversion apparatus according to an embodiment of the present disclosure.

FIG. 8 is a schematic view of an environment in which a method of extracting landmark data from a face included in an image is performed, according to the present disclosure.

FIG. 9 is a schematic view of a configuration of a landmark data decomposition apparatus according to an embodiment of the present disclosure.

FIG. 10 is a diagram for describing a method of extracting landmark data of a face, according to an embodiment of the present disclosure.

FIG. 11 is a flowchart of a method of extracting various types of landmark data, according to an embodiment of the present disclosure.

FIG. 12 is a diagram illustrating a process of transforming a facial expression included in an image, according to another embodiment of the present disclosure.

FIG. 13 is a comparison table for describing an effect of transforming a facial expression of a face included in an image by using a landmark data decomposition method according to the present disclosure.

FIG. 14 is a schematic view of a configuration of a landmark data decomposition apparatus according to an embodiment of the present disclosure.

FIG. 15 is a schematic view of an environment in which a landmark decomposition apparatus operates, according to the present disclosure.

FIG. 16 is a schematic flowchart of a landmark decomposition method according to an embodiment of the present disclosure.

FIG. 17 is a schematic view illustrating a method of calculating a transformation matrix according to an embodiment of the present disclosure.

FIG. 18 is a schematic diagram illustrating a landmark decomposition apparatus according to an embodiment of the present disclosure.

FIG. 19 is a diagram illustrating a method of reproducing a face according to the present disclosure.

FIG. 20 schematically illustrates an image transformation apparatus according to the present disclosure and an environment in which an image transformation method according to the present disclosure operates.

FIG. 21 is a schematic flowchart of an image transformation method according to an embodiment of the present disclosure.

FIG. 22 is an exemplary view of a result of performing an image transformation method according to an embodiment of the present disclosure.

FIG. 23 is a schematic diagram illustrating an image transformation apparatus according to an embodiment of the present disclosure.

FIG. 24 is a schematic diagram illustrating a configuration of a landmark obtainer according to an embodiment of the present disclosure.

FIG. 25 is a schematic diagram illustrating a second encoder according to an embodiment of the present disclosure.

FIG. 26 is a schematic diagram illustrating a structure of a blender according to an embodiment of the present disclosure.

FIG. 27 is a schematic diagram illustrating a decoder according to an embodiment of the present disclosure.

FIGS. 28A to 28C show examples of identity preservation failures and improved results generated by the proposed method. FIG. 28A shows driver shape interference,

FIG. 28B shows losing details of target identity, and FIG. 28C shows failure of warping at large poses.

FIG. 29 is an overall architecture of MarioNETte.

FIG. 30 is an architecture of an image attention block.

FIG. 31 is an architecture of target feature alignment.

FIG. 32 is an architecture of landmark disentangler.

FIG. 33 are images generated by the proposed method and baselines, reenacting different identity on CelebV in one-shot setting.

FIG. 34 illustrates evaluation result of self-reenactment setting on VoxCeleb1.

FIG. 35 illustrates evaluation result of reenacting a different identity on CelebV.

FIG. 36 illustrates user study results of reenacting different identity on CelebV.

FIG. 37 illustrates comparison of ablation models for reenacting different identity on CelebV.

FIG. 38A illustrates driver and target images overlapped with attention map, and

FIG. 38B illustrates a failure case of +Alignment and improved result generated by MarioNETte.

FIG. 39 is an example of the rasterized facial landmarks.

FIG. 40 illustrates comparison of ablation models for self-reenactment setting on VoxCeleb1 dataset.

FIG. 41 illustrates inference speed of each component of our model.

FIG. 42 illustrates inference speed of the full model for generating single image with K target images.

FIG. 43 are qualitative results of ablation models of one-shot reenactment under different identity setting on CelebV.

FIG. 44 are qualitative results of ablation models of few-shot reenactment under different identity setting on CelebV.

FIG. 45 are qualitative results of one-shot self-reenactment setting on VoxCeleb1.

FIG. 46 are qualitative results of few-shot self-reenactment setting on VoxCeleb1.

FIG. 47 are qualitative results of one-shot reenactment under different identity setting on VoxCeleb1.

FIG. 48 are qualitative results of few-shot reenactment under different identity setting on VoxCeleb1.

FIG. 49 are qualitative results of one-shot self-reenactment setting on CelebV.

FIG. 50 are qualitative results of few-shot self-reenactment setting on CelebV.

FIG. 51 are qualitative results of few-shot reenactment under different identity setting on CelebV.

FIG. 52 are failure cases generated by MarioNETte+LT while performing one-shot reenactment under different identity setting on VoxCeleb1.

### MODE OF DISCLOSURE

Advantages and features of the present disclosure and methods of accomplishing the same will become more apparent by the embodiments described below in detail with reference to the accompanying drawings. In this regard, the embodiments of the present disclosure may have different forms and should not be construed as being limited to the descriptions set forth herein. Rather, these embodiments will give a comprehensive understanding of the present disclosure and fully convey the scope of the present disclosure to those of ordinary skill in the art, and the present disclosure will only be defined by the appended claims. The same reference numerals refer to the same elements throughout the specification.

Although the terms such as “first”, “second”, and so forth, can be used for describing various elements, the elements are not limited to the terms. The terms as described above may be used only to distinguish one element from another element. Accordingly, first elements mentioned below may refer to second elements within the technical idea of the present disclosure.

The terms used herein should be considered in a descriptive sense only and not for purposes of limitation. As used herein, the singular forms “a”, “an”, and “the” are intended to include the plural forms as well, unless the context clearly indicates otherwise. It will be understood that the term such as “include (or including)” or “comprise (or comprising)” used herein is inclusive or open-ended and does not exclude the presence or addition of elements or method operations.

Unless defined otherwise, all the terms used herein may be construed as meanings that may be commonly understood by those of ordinary skill in the art. Also, the terms as those defined in generally used dictionaries are not construed ideally or excessively, unless clearly defined otherwise in particular.

FIG. 1 is a schematic view of an environment in which an image conversion method is performed, according to the present disclosure. Referring to FIG. 1, the environment in which the image conversion method is performed, according to the present disclosure, may include a server 10 and a terminal 20 connected to the server 10. For convenience of description, only one terminal is shown in FIG. 1, but a plurality of terminals may be included. Except for a description to be particularly mentioned, a description of the terminal 20 may be applied to a terminal that may be added.

In embodiments of the present disclosure, the server 10 may receive an image from the terminal 20, transform the received image into an arbitrary form, and transmit the transformed image to the terminal 20. Alternatively, the server 10 may function as a platform for providing a service that the terminal 20 may access and use. The terminal 20 may transform an image selected by a user of the terminal 20 and transmit the transformed image to the server 10.

The server 10 may be connected to a communication network. The server 10 may be connected to another external device through the communication network. The server 10 may transmit or receive data to or from the other external device connected thereto.

The communication network connected to the server 10 may include a wired communication network, a wireless communication network, or a combined complex communication network. A communication network may include mobile communication networks such as 3G, LTE, or LTE-A. A communication network may include a wired or wireless communication network such as Wi-Fi, UMTS/GPRS, or Ethernet. The examples of the communication network may include local area communication network such as MST, RFID, NFC, Zigbee, Z-Wave, Bluetooth, BLE, or infrared communication. The examples of the communication network may include a LAN, a MAN, or a WAN.

The server 10 may be connected to the terminal 20 through the communication network. When the server 10 is connected to the terminal 20, the server 10 may transmit and receive data to and from the terminal 20 through the communication network. The server 10 may perform an arbitrary operation using the data received from the terminal 20. The server 10 may transmit a result of the operation to the terminal 20.

Examples of the terminal 20 may include a desktop computer, a smartphone, a smart tablet, a smartwatch, a mobile terminal, a digital camera, a wearable device, or a portable electronic device. The terminal 20 may execute a program or an application.

FIG. 2 is a schematic view of a configuration of an image conversion apparatus according to an embodiment of the present disclosure.

Referring to FIG. 2, an image conversion apparatus 100 according to an embodiment of the present disclosure includes an image receiver 110, a template obtainer 120, and an image transformer 130. The image conversion apparatus 100 may be configured by the server 10 or the terminal 20 described with reference to FIG. 1. Accordingly, each of the elements included in the image conversion apparatus 100 may also be configured by the server 10 or the terminal 20.

The image receiver 110 receives an image from a user. The image may include a user's face, and may include a still image or a static image. A size of the user's face included in the image may be different depending on images. For example, a size of a face included in image 1 may be a pixel size of 100×100, and a size of a face included in image 2 may be a pixel size of 200×200.

The image receiver 110 may extract only a face area from the image received from the user, and then provide the extracted face area to the image transformer 130.

The image receiver 110 may extract an area corresponding to the user's face from the image including the user's face into a predetermined size. For example, when the predetermined size is 100×100 and the size of the area corresponding to the user's face included in the image is 200×200, the image receiver 110 may reduce the image having the size of 200×200 into an image having a size of 100×100, and then extract the reduced image. Alternatively, a method of extracting an image having a size of 200×200 and then transforming the image into an image having a size of 100×100 may be used.

The template obtainer 120 obtains at least one image conversion template. The image conversion template may be understood as a tool capable of transforming an image received by the image receiver 110 into a new image in a specific shape. For example, when a user's expressionless face is included in the image received by the image receiver 110, a new image including a user's smiling face may be generated by using a specific image conversion template.

The image conversion template may be determined in advance as an arbitrary template, or may be selected by the user.

The image transformer 130 may receive, from the image receiver 110, a static image corresponding to the face area. Also, the image transformer 130 may transform the static image into a moving image by using the image conversion template obtained by the template obtainer 120.

FIG. 3 is a schematic flowchart of an image conversion method according to an embodiment of the present disclosure.

Referring to FIG. 3, the image conversion method according to an embodiment of the present disclosure may include an operation S110 of receiving a static image, an operation S120 of obtaining an image conversion template, and an operation S130 of generating a moving image.

The image conversion method according the present disclosure uses an artificial neural network, and a static image may be obtained in operation S110. The static image may include a user's face and may include one frame.

In operation S120, at least one of a plurality of image conversion templates stored in the image conversion apparatus 100 may be obtained. The image conversion template may be selected by a user from among the plurality of image conversion templates stored in the image conversion apparatus 100.

The image conversion template may be understood as a tool capable of transforming an image received in operation S110 into a new image in a specific shape. For example, when a user's expressionless face is included in the image received in operation S110, a new image including a user's smiling face may be generated by using a specific image conversion template.

In another embodiment, when a user's smiling face is included in the image received in operation S110, a new image including a user's angry face may be generated by using another specific image conversion template.

In some embodiments, in operation S120, at least one reference image may be received from the user. For example, the reference image may include an image obtained by capturing the user, or an image of another person selected by the user. When the user does not select one of a plurality of preset templates and selects the reference image, the reference image may be obtained as the image conversion template. That is, it may be understood that the reference image performs the same function as the image conversion template.

In operation S130, the static image may be converted into a moving image by using the obtained image conversion template. In order to transform the static image into the moving image, texture information may be extracted from the user's face included in the static image. The texture information may include information about a color or visual texture of the user's face.

Also, in order to transform the static image into the moving image, landmark information may be extracted from an area corresponding to a person's face included in the image conversion template. The landmark information may be obtained from a specific shape, pattern, and color included in the person's face, or a combination thereof, based on an image processing algorithm. Also, the image processing algorithm may include one of SIFT, HOG, Haar feature, Ferns, LBP, and MCT, but is not limited thereto.

The moving image may be generated by combining the texture information and the landmark information. In some embodiments, the moving image may include a plurality of frames. In the moving image, a frame corresponding to the static image may be set as a first frame, and a frame corresponding to the image conversion template may be set as a last frame.

For example, a user's facial expression included in the static image may be the same as a facial expression included in the first frame included in the moving image. Moreover, when the texture information and the landmark information are combined, the user's facial expression included in the static image may be transformed in response to the landmark information, and the last frame included in the moving image may include a frame corresponding to the user's transformed facial expression.

When the moving image is generated using the artificial neural network, the moving image may gradually change from the user's facial expression included in the static image to the user's facial expression transformed in response to the landmark information. That is, at least one frame may be included between the first frame and the last frame of the moving image, and a facial expression included in each of the at least one frame may gradually change.

By using the artificial neural network, even though the user does not directly capture a moving image, a moving image having the same effect as a moving image captured by the user directly changing his or her facial expressions may be generated.

FIG. 4 is a diagram illustrating an image conversion template according to an embodiment of the present disclosure.

A plurality of image conversion templates may be stored in the image conversion apparatus 100. Each of the plurality of image conversion templates may include outline images respectively corresponding to eyebrows, eyes, and a mouth. The plurality of image conversion templates may correspond to various facial expressions such as a sad expression, a joyful expression, a winking expression, a depressed expression, a blank expression, a surprised expression, an angry expression, etc., and the plurality of image conversion templates include information about different facial expressions, respectively. Outline images respectively corresponding to the various facial expressions are different from each other. Accordingly, the plurality of image conversion templates may include different outline images, respectively.

Referring to FIG. 2, the image transformer 130 may extract landmark information from outline images included in the image conversion templates.

FIG. 5A is a diagram illustrating a process of generating a moving image according to an embodiment of the present disclosure.

Referring to FIGS. 4 and 5A, a static image 31, an image conversion template 32, and a moving image 33 generated using the static image 31 and the image conversion template 32 are shown. For example, the static image 31 may include a user's smiling face. The image conversion template 32 may include outline images respectively corresponding to eyebrows, eyes, and a mouth of a winking and smiling face.

Although it may be seen that the moving image 33 shown in FIG. 5A includes only one frame, it may be understood that the moving image 33 shows a last frame constituting the moving image generated by the image transformer 130 or generated in operation S130.

The image conversion apparatus 100 may extract, from the static image 31, texture information of an area corresponding to the user's face. Also, the image conversion apparatus 100 may extract landmark information from the image conversion template 32. The image conversion apparatus 100 may generate the moving image 33 by combining the texture information of the static image 31 and the landmark information of the image conversion template 32.

The moving image 33 is shown as an image including a user's winking face.

However, the moving image 33 includes a plurality of frames. The moving image 33 including the plurality of frames will be described with reference to FIG. 5B.

FIG. 5B is a diagram illustrating a moving image generated according to an embodiment of the present disclosure.

Referring to FIGS. 5A and 5B, at least one frame may be present between a first frame 33_1 and a last frame 33_n of the moving image 33. For example, the static image 31 may correspond to the first frame 33_1 of the moving image 33. Also, the image including the user's winking face may correspond to the last frame 33_n of the moving image 33.

Each of the at least one frame present between the first frame 33_1 and the last frame 33_n of the moving image 33 may include an image of the user's face, whose eyes are gradually shut.

FIG. 6A is a diagram illustrating a process of generating a moving image according to another embodiment of the present disclosure.

Referring to FIGS. 4 and 6A, a static image 41, a reference image 42, and a moving image 43 generated using the static image 41 and the reference image 42 are shown. For example, the static image 41 may include a user's smiling face. The reference image 42 may include a winking face with a big smile. A face included in the reference image 42 may be a person's face, the person being different from the user.

Although it may be seen that the moving image 43 shown in FIG. 6A includes only one frame, it may be understood that the moving image 43 shows a last frame constituting the moving image generated by the image transformer 130 or generated in operation S130.

The image conversion apparatus 100 may extract, from the static image 41, texture information of an area corresponding to the user's face. Also, the image conversion apparatus 100 may extract landmark information from the reference image 42. The image conversion apparatus 100 may extract landmark information from areas, of the face included in the reference image 42, respectively corresponding to eyebrows, eyes, and a mouth. The image conversion apparatus 100 may generate the moving image 43 by combining the texture information of the static image 41 and the landmark information of the reference image 42.

The moving image 43 is shown as an image including a user's winking face with a big smile. However, the moving image 43 includes a plurality of frames. The moving image 43 including the plurality of frames will be described with reference to FIG. 6B.

FIG. 6B is a diagram illustrating a moving image generated according to another embodiment of the present disclosure.

Referring to FIGS. 6A and 6B, at least one frame may be present between a first frame 43_1 and a last frame 43_n of the moving image 43. For example, the static image 41 may correspond to the first frame 43_1 of the moving image 43. Also, the image including the user's winking face with a big smile may correspond to the last frame 43_n of the moving image 43.

Each of the at least one frame present between the first frame 43_1 and the last frame 43_n of the moving image 43 may include an image of the user's face, whose eyes are gradually shut and mouth is gradually opened.

FIG. 7 is a schematic view of a configuration of an image conversion apparatus according to an embodiment of the present disclosure.

Referring to FIG. 7, an image conversion apparatus 200 may include a processor 210 and a memory 220. Those of ordinary skill in the art related to the present embodiment would be able to see that other general elements may be further included in addition to elements shown in FIG. 13.

The image conversion apparatus 200 may be similar or identical to the image conversion apparatus 100 shown in FIG. 2. The image receiver 110, the template obtainer 120, and the image transformer 130 included in the image conversion apparatus 100 may be included in the processor 210.

The processor 210 may control overall operations of the image conversion apparatus 200 and may include at least one processor such as a central processing unit (CPU), or the like. The processor 210 may include at least one specialized processor corresponding to each function, or may include an integrated processor.

The memory 220 may store programs, data, or files related to the artificial neural network. The memory 220 may store instructions executable by the processor 210. The processor 210 may execute the programs stored in the memory 220, read the data or files stored in the memory 220, or store new data. Also, the memory 220 may store program commands, data files, data structures, etc. separately or in combination.

The processor 210 may obtain a static image from an input image. The static image may include a user's face and may include one frame.

The processor 210 may read at least one of a plurality of image conversion templates stored in the memory 220. Alternatively, the processor 210 may read at least one reference image stored in the memory 220. For example, the at least one reference image may be input by a user.

The reference image may include an image obtained by capturing the user, or an image of another person selected by the user. When the user does not select one of a plurality of preset templates and selects the reference image, the reference image may be obtained as the image conversion template.

The processor 210 may transform the static image into a moving image by using the obtained image conversion template. In order to transform the static image into the moving image, texture information may be extracted from the user's face included in the static image. The texture information may include information about a color or visual texture of the user's face.

Also, in order to transform the static image into the moving image, landmark information may be extracted from an area corresponding to a person's face included in the image conversion template. The landmark information may be obtained from a specific shape, pattern, and color included in the person's face, or a combination thereof, based on an image processing algorithm. Also, the image processing algorithm may include one of SIFT, HOG, Haar feature, Ferns, LBP, and MCT, but is not limited thereto.

The moving image may be generated by combining the texture information and the landmark information. The moving image may include a plurality of frames. In the moving image, a frame corresponding to the static image may be set as a first frame, and a frame corresponding to the image conversion template may be set as a last frame.

For example, a user's facial expression included in the static image may be the same as a facial expression included in the first frame included in the moving image. Moreover, when the texture information and the landmark information are combined, the user's facial expression included in the static image may be transformed in response to the landmark information, and the last frame included in the moving image may include a frame corresponding to the user's transformed facial expression. The moving image generated by the processor 210 may have a shape as shown in FIGS. 5B and 6B.

The processor 210 may store the generated moving image in the memory 220 and output the moving image to be seen by the user.

As described with reference to FIGS. 1 to 7, when the user uploads the static image to a user's terminal 20, the image conversion apparatus 200 may transform the static image into a moving image and provide the transformed moving image to the user. Even though the user does not directly capture a moving image, a moving image having the same effect as a moving image captured by the user directly changing his or her facial expressions may be provided.

Also, the image conversion apparatus 200 may provide the user with a moving image generated by transforming a static image, to thereby provide the user with an interesting user experience along with the moving image.

FIG. 8 is a schematic view of an environment in which a method of extracting landmark data from a face included in an image is performed, according to the present disclosure.

Referring to FIG. 8, the environment in which the method of extracting landmark data is performed, according to the present disclosure, may include a server 10-1 and a terminal 20-1 connected to the server 10-1. For convenience of description, only one terminal is shown in FIG. 8, but a plurality of terminals may be included. Except for a description to be particularly mentioned, a description of the terminal 20-1 may be applied to a terminal that may be added.

In an embodiment of the present disclosure, the server 10-1 may receive an image from the terminal 20-1, extract landmark data from a face included in the received image, calculate necessary data from the extracted landmark data, and then transmit the calculated data to the terminal 20-1.

Alternatively, the server 10-1 may function as a platform for providing a service that the terminal 20-1 may access and use. The terminal 20-1 may extract landmark data from a face included in an image, calculate necessary data from the extracted landmark data, and then transmit the calculated data to the server 10-1.

The server 10-1 may be connected to a communication network. The server 10-1 may be connected to another external device through the communication network. The server 10-1 may transmit or receive data to or from the other external device connected thereto.

The communication network connected to the server 10-1 may include a wired communication network, a wireless communication network, or a combined complex communication network. A communication network may include mobile communication networks such as 3G, LTE, or LTE-A. A communication network may include a wired or wireless communication network such as Wi-Fi, UMTS/GPRS, or Ethernet. The examples of the communication network may include local area communication network such as MST, RFID, NFC, Zigbee, Z-Wave, Bluetooth, BLE, or infrared communication. The examples of the communication network may include a LAN, a MAN, or a WAN.

The server 10-1 may be connected to the terminal 20-1 through the communication network. When the server 10-1 is connected to the terminal 20-1, the server 10-1 may transmit and receive data to and from the terminal 20-1 through the communication network. The server 10-1 may perform an arbitrary operation using the data received from the terminal 20-1. The server 10-1 may transmit a result of the operation to the terminal 20-1.

Examples of the terminal 20-1 may include a desktop computer, a smartphone, a smart tablet, a smartwatch, a mobile terminal, a digital camera, a wearable device, or a portable electronic device. The terminal 20-1 may execute a program or an application.

FIG. 9 is a schematic view of a configuration of a landmark data decomposition apparatus according to an embodiment of the present disclosure.

Referring to FIG. 9, a landmark data decomposition apparatus 100-1 according to an embodiment of the present disclosure may include an image receiver 110-1, a landmark data calculator 120-1, and a landmark data storage 130-1. The landmark data decomposition apparatus 100-1 may be configured by the server 10-1 or the terminal 20-1 described with reference to FIG. 8. Accordingly, each of the elements included in the landmark data decomposition apparatus 100-1 may also be configured by the server 10-1 or the terminal 20-1.

The image receiver 110-1 may receive a plurality of images from a user. Each of the plurality of images may include only one person. That is, each of the plurality of images may include only one person's face, and people included in the plurality of images may all be different people.

The image receiver 110-1 may extract only a face area from each of the plurality of images, and then provide the extracted face area to the landmark data calculator 120-1.

The landmark data calculator 120-1 may calculate landmark data of faces respectively included in the plurality of images, mean landmark data of all faces included in the plurality of images, and characteristic landmark data of a specific face included in a specific image among the plurality of images, and facial expression landmark data of the specific face.

In some embodiments, the landmark data may include a result of extracting facial key points. A method of extracting landmark data may be described with reference to FIG. 10.

FIG. 10 is a diagram for describing a method of extracting landmark data of a face, according to an embodiment of the present disclosure.

The landmark data may be obtained by extracting points of major elements of a face, such as eyes, eyebrows, a nose, a mouth, and a jawline or extracting an outline drawn by connecting the points. The landmark data may be used in techniques such as facial expression classification, pose analysis, synthesis of faces of different people, face transformation, etc.

Referring back to FIG. 9, the landmark data calculator 120-1 may calculate mean landmark data of the faces included in the plurality of images. It may be assumed that the mean landmark data is a result of extracting an average shape of people's faces.

The landmark data calculator 120-1 may calculate landmark data from the specific image including the specific face, among the plurality of images. In more detail, landmark data for a specific face included in a specific frame among a plurality of frames included in a specific image may be calculated.

Also, the landmark data calculator 120-1 may calculate characteristic landmark data of the specific face included in the specific image among the plurality of images. The characteristic landmark data may be calculated based on face landmark data included in each of the plurality of frames included in the specific image.

Also, the landmark data calculator 120-1 may calculate facial expression landmark data for the specific frame in the specific image by calculating the mean landmark data, the landmark data for the specific frame, and characteristic landmark data. For example, the facial expression landmark data may correspond to a facial expression of the specific face or movement information of major elements such as eyes, eyebrows, a nose, a mouth, and a jawline.

The landmark data storage 130-1 may store the data calculated by the landmark data calculator 120-1. For example, the landmark data storage 130-1 may store the mean landmark data, the landmark data for the specific frame, the characteristic landmark data, and the facial expression landmark data, which are calculated by the landmark data calculator 120-1.

FIG. 11 is a flowchart of a method of extracting various types of landmark data, according to an embodiment of the present disclosure.

Referring to FIGS. 9 and 11, in operation S1100, the landmark data decomposition apparatus 100-1 may receive a plurality of images. Each of the plurality of images may include only one person. That is, each of the plurality of images may include only one person's face, and people included in the plurality of images may all be different people.

In operation S1200, the landmark data decomposition apparatus 100-1 may calculate mean landmark data Iₘ. The mean landmark data Iₘ may be represented as follows.

$${I}_{m} = \frac{1}{CT} {\sum }_{c} {\sum }_{t} {I}_{( c , t )} \qquad [ Equation 1 ]$$

In an embodiment of the present disclosure, C may denote the number of a plurality of images, and T may denote the number of frames included in each of the plurality of images.

That is, the landmark data decomposition apparatus 100-1 may extract landmark data I_{(c,t)} of each of faces included in the plurality of images C. The landmark data decomposition apparatus 100 may calculate a mean value of all pieces of the extracted landmark data. The calculated mean value may correspond to mean landmark data Iₘ.

In operation S1300, the landmark data decomposition apparatus 100-1 may calculate landmark data I_{(c,t)} for a specific frame among a plurality of frames in a specific image including a specific face, among the plurality of images.

For example, the landmark data I_{(c,t)} for the specific frame may be information about a facial key point of a specific face included in a t-th frame of a c-th image among a plurality images C. That is, it may be assumed that the specific image is the c-th image, and the specific frame is the t-th frame.

In operation S1400, the landmark data decomposition apparatus 100-1 may calculate characteristic landmark data I_{id(c)} of the specific face included in the c-th image. The characteristic landmark data I_{id(c)} may be represented as follows.

$${I}_{id ( c )} = \frac{1}{{T}_{c}} {\sum }_{t ∈ {T}_{c}} {I}_{( c , t )} - {I}_{m} \qquad [ Equation 2 ]$$

In an embodiment of the present disclosure, a plurality of frames included in the c-th image include various facial expressions of the specific face. Accordingly, in order to calculate the characteristic landmark data I_{id(c)}, the landmark data decomposition apparatus 100-1 may assume that a mean value

$$\frac{1}{{T}_{c}} {\sum }_{t ∈ {T}_{c}} {I}_{exp ( c , t )}$$

of facial expression landmark data Iₑₓₚ of the specific face included in the c-th image is 0. Therefore, the characteristic landmark data I_{id(c)} may be calculated without considering the mean value

$$\frac{1}{{T}_{c}} {\sum }_{t ∈ {T}_{c}} {I}_{exp ( c , t )}$$

of the facial expression landmark data Iₑₓₚ of the specific face.

The characteristic landmark data I_{id(c)} may be defined as a value obtained by calculating landmark data for each of the plurality of frames included in the c-th image, calculating the mean landmark data

$$\frac{1}{{T}_{c}} {\sum }_{t ∈ {T}_{c}} {I}_{( c , t )}$$

of the landmark data for each of the plurality of frames, and subtracting mean landmark data Iₘ of the plurality of images from the calculated mean landmark data

$$( \frac{1}{{T}_{c}} {\sum }_{t ∈ {T}_{c}} {I}_{( c , t )} )$$

of the c-th image.

In operation S1500, the landmark data decomposition apparatus 100-1 may calculate facial expression landmark data I_{exp(c,t)} of the specific face.

In more detail, the landmark data decomposition apparatus 100-1 may calculate facial expression landmark data I_{exp(c,t)} of the specific face included in the t-th frame of the c-th image. The facial expression landmark data I_{exp(c,t)} may be represented as follows.

$${I}_{exp ( c , t )} = {I}_{( c , t )} - {I}_{m} - {I}_{id ( c )} = {I}_{( c , t )} - \frac{1}{{T}_{c}} {\sum }_{t ∈ {T}_{c}} {I}_{( c , t )} \qquad [ Equation 3 ]$$

The facial expression landmark data I_{exp(c,t)} may correspond to a facial expression of the specific face included in the t-th frame and movement information of eyes, eyebrows, a nose, a mouth, and a jawline included in the specific face. In more detail, the facial expression landmark data I_{exp(c,t)} may be defined as a value obtained by subtracting the mean landmark data Iₘ and the characteristic landmark data I_{id(c)} from the landmark data I_{(c,t)} for the specific frame.

Through an operation as described with reference to FIG. 11, the landmark data decomposition apparatus 100 may decompose landmark data of a face included in an image. The landmark data decomposition apparatus 100-1 may obtain facial key points of a face included in an image, as well as a facial expression and movement information of the face.

The server 10-1 or the terminal 20-1 may implement a technique of transforming a facial expression of a first image into a facial expression of a face included in a second image while maintaining an external shape of a face included in the first image, by using the facial expression landmark data I_{exp(c,t)}, the mean landmark data Iₘ, and the characteristic landmark data I_{id(c)} which are decomposed by the landmark data decomposition apparatus 100-1. A detailed method thereof may be described with reference to FIG. 12.

FIG. 12 is a diagram illustrating a process of transforming a facial expression included in an image, according to another embodiment of the present disclosure.

Referring to FIGS. 11 and 12, the server 10-1 or the terminal 20-1 may transform only a facial expression of a first image 300 into a facial expression of a face included in a second image 400 while maintaining an external shape of a face included in the first image 300, by using the facial expression landmark data I_{exp(c,t)}, the mean landmark data Iₘ, and the characteristic landmark data I_{id(c)}, which are decomposed by the landmark data decomposition apparatus 100-1.

For example, the first image 300 may correspond to a tₓ-th frame among a plurality of frames included in a cₓ-th image among a plurality of images. Also, the second image 400 may correspond to a t_{y}-th frame among a plurality of frames included in a c_{y}-th image among a plurality of images. The cₓ-th image and the c_{y}-th image may be different from each other.

Landmark data of the face included in the first image 300 may be decomposed as follows.

I_{(c}_{ₓ}_{,t}_{ₓ}₎=Iₘ+I_{id(c}_{ₓ}₎+I_{exp(c}_{ₓ}_{,t}_{ₓ}₎ [Equation 4]

The landmark data I_{(c}_{ₓ}_{,t}_{ₓ}₎ of the face included in the first image 300 may be expressed as a result of a sum of the mean landmark data Iₘ, the characteristic landmark data I_{id(c}_{ₓ}₎, and the expression landmark data I_{(c}_{ₓ}_{,t}_{ₓ}₎.

Landmark data of the face included in the second image 400 may be decomposed as follows.

I_{(c}_{ₓ}_{,t}_{ₓ}₎=Iₘ+I_{id(c}_{_{y}}₎+I_{(c}_{_{y}}_{,t}_{_{y}}₎ [Equation 5]

The landmark data I_{(c}_{_{y}}_{,t}_{_{y}}₎ of the face included in the second image 400 may be expressed as a result of a sum of the mean landmark data Iₘ, the characteristic landmark data I_{id(c}_{_{y}}₎, and the expression landmark data I_{exp(c}_{_{y}}_{,t}_{_{y}}₎.

In order to transform only the facial expression of the first image 300 into the facial expression of the face included in the second image 400 while maintaining the external shape of the face included in the first image 300, the landmark data of the face included in the first image 300 may be expressed as follows.

I_{(c}_{_{y}}_{→c}_{ₓ}ₜ_{_{y}}₎=Iₘ+I_{id(c}_{ₓ}₎+I_{(c}_{_{y}}_{,t}_{_{y}}₎ [Equation 6]

The server 10-1 or the terminal 20-1 may substitute the facial expression landmark data I_{id(c}_{ₓ}₎ of the face included in the first image 300 with the facial expression landmark data I_{exp(c}_{ₓ}_{,t}_{ₓ}₎ of the face included in the second image 400, while maintaining the characteristic landmark data I_{exp(c}_{_{y}}_{,t}_{_{y}}₎ of the face included in the first image 300.

By using such a method, the first image 300 may be converted into a third image 500. Although the face included in the first image 300 had a smiling expression, a face included in the third image 500 has a winking expression with a big smile, as in the facial expression of the face included in the second image 400.

FIG. 13 is a comparison table for describing an effect of transforming a facial expression of a face included in an image by using a landmark data decomposition method according to the present disclosure.

A MarioNETte model is used to transform a facial expression of a face included in an image without using the landmark data decomposition method. When the MarioNETte model is used, a result of measuring the degree of naturalness of a transformed image is 0.147.

A MarioNETte+LT model is used to transform a facial expression of a face included in an image using the landmark data decomposition method. When the MarioNETte+LT model is used, a result of measuring the degree of naturalness of a transformed image is 0.280. That is, it is verified that the image transformed using the MarioNETte+LT model is 1.9 times more natural than the image transformed using the MarioNETte model.

FIG. 14 is a schematic view of a configuration of a landmark data decomposition apparatus according to an embodiment of the present disclosure.

Referring to FIG. 14, a landmark data decomposition apparatus 200-1 may include a processor 210-1 and a memory 220-1. Those of ordinary skill in the art related to the present embodiment would be able to see that other general elements may be further included in addition to elements shown in FIG. 14.

The image conversion apparatus 200-1 may be similar or identical to the landmark data decomposition apparatus 100-1 shown in FIG. 9. The image receiver 110-1 and the landmark data calculator 120-1 included in the landmark data decomposition apparatus 100-1 may be included in the processor 210-1.

The processor 210-1 may control overall operations of the landmark data decomposition apparatus 200-1, and may include at least one processor such as a CPU, or the like. The processor 210-1 may include at least one specialized processor corresponding to each function, or may include an integrated processor.

The memory 220-1 may store programs, data, or files that control the landmark data decomposition apparatus 200-1. The memory 220-1 may store instructions executable by the processor 210-1. The processor 210-1 may execute the programs stored in the memory 220-1, read the data or files stored in the memory 220-1, or store new data. Also, the memory 220-1 may store program commands, data files, data structures, etc. separately or in combination.

The processor 210-1 may receive a plurality of images. Each of the plurality of images may include only one person. That is, each of the plurality of images may include only one person's face, and people included in the plurality of images may all be different people.

The processor 210-1 may store the plurality of received image in the memory 220-1.

The processor 210-1 may extract landmark data I_{(c,t)} of each of faces included in a plurality of images C. The landmark data decomposition apparatus 100-1 may calculate a mean value of all pieces of the extracted landmark data. The calculated mean value may correspond to mean landmark data Iₘ.

The processor 210-1 may calculate landmark data I_{(c,t)} for a specific frame among a plurality frames in a specific image including a specific face, among the plurality of images.

The landmark data I_{(c,t)} for the specific frame may be information of a facial key point of a specific face included in a t-th frame of a c-th image among the plurality images C. That is, it may be assumed that the specific image is the c-th image, and the specific frame is the t-th frame.

The processor 210-1 may calculate characteristic landmark data I_{id(c)} of the specific face included in the c-th image. A plurality of frames included in the c-th image include various facial expressions of the specific face. Accordingly, in order to calculate the characteristic landmark data I_{id(c)}, the processor 210-1 may assume that a mean value

$$\frac{1}{{T}_{c}} {\sum }_{t ∈ {T}_{c}} {I}_{exp ( c , t )}$$

of facial expression landmark data Iₑₓₚ of the specific face included in the c-th image is 0. Therefore, the characteristic landmark data I_{id(c)} may be calculated without considering the mean value

$$\frac{1}{{T}_{c}} {\sum }_{t ∈ {T}_{c}} {I}_{exp ( c , t )}$$

of the facial expression landmark data Iₑₓₚ of the specific face.

The characteristic landmark data I_{id(c)} may be defined as a value obtained by calculating landmark data for each of the plurality of frames included in the c-th image, calculating the mean landmark data

$$\frac{1}{{T}_{c}} {\sum }_{t ∈ {T}_{c}} {I}_{( c , t )}$$

of the landmark data for each of the plurality of frames, and subtracting mean landmark data Iₘ of the plurality of images from the calculated mean landmark data

$$\frac{1}{{T}_{c}} {\sum }_{t ∈ {T}_{c}} {I}_{( c , t )}$$

of the c-th image.

The processor 210-1 may calculate facial expression landmark data I_{exp(c,t)} of the specific face included in the t-th frame of the c-th image. The facial expression landmark data I_{exp(c,t)} may correspond to a facial expression of the specific face included in the t-th frame and movement information of eyes, eyebrows, a nose, a mouth, and a jawline included in the specific face. In more detail, the facial expression landmark data I_{exp(c,t)} may be defined as a value obtained by subtracting the mean landmark data Iₘ and the characteristic landmark data I_{id(c)} from the landmark data I_{(c,t)} for the specific frame.

The processor 210-1 may store, in the memory 220-1, the facial expression landmark data I_{exp(c,t)}, the mean landmark data Iₘ, and the characteristic landmark data I_{id(c)}, which are decomposed.

As described with reference to FIGS. 8 through 14, the landmark data decomposition apparatuses 100-1 and 200-1 according to the embodiments of the present disclosure may decompose landmark data more accurately and precisely from a face included in an image.

Also, the landmark data decomposition apparatuses 100-1 and 200-1 may decompose landmark data including information about characteristics and facial expressions of a face included in an image more accurately.

Moreover, the server 10-1 or the terminal 20-1 including the landmark data decomposition apparatuses 100-1 and 200-1 may implement a technique of naturally transforming a facial expression of a first image into a facial expression of a face included in a second image while maintaining an external shape of a face included in the first image, by using facial expression landmark data I_{exp(c,t)}, mean landmark data Iₘ, and characteristic landmark data I_{id(c)}, which are decomposed.

FIG. 15 is a schematic view of an environment in which a landmark decomposition apparatus operates, according to the present disclosure. Referring to FIG. 15, an environment in which a first terminal 2000 and a second terminal 2000 operate may include a server 1000, and the first terminal 2000 and the second terminal 3000 that are connected to the server 1000. For convenience of description, only two terminals, that is, the first terminal 2000 and the second terminal 3000, are illustrated in FIG. 15, but two or more terminals may also be included. Regarding further terminals that may be added here, except for details to be particularly mentioned, the description regarding the first terminal 2000 and the second terminal 3000 may apply.

The server 1000 may be connected to a communication network. The server 1000 may be connected to other external devices through the communication network. The server 1000 may transmit data to another connected device or receive data from the other device.

The communication network connected to the server 1000 may include a wired communication network, a wireless communication network or a complex communication network. A communication network may include mobile communication networks such as 3G, LTE, or LTE-A. A communication network may include a wired or wireless communication network such as Wi-Fi, UMTS/GPRS, or Ethernet. A communication network may include short-range communication networks such as Magnetic Secure Transmission) (MST), Radio Frequency Identification (RFID), Near Field Communication (NFC), ZigBee, Z-Wave, Bluetooth, Bluetooth Low Energy (BLE), or Infrared (IR) communication), or the like. A communication network may include a local area network (LAN), a metropolitan area network (MAN), or a wide area network (WAN).

The server 1000 may include data from at least one of the first terminal 2000 and the second terminal 3000. The server 1000 may perform operation by using data received from at least one of the first terminal 2000 and the second terminal 3000. The server 1000 may transmit a result of the operation to at least one of the first terminal 2000 and the second terminal 3000.

The server 1000 may receive a relay request from at least one terminal from among the first terminal 2000 and the second terminal 3000. The server 1000 may select a terminal that has transmitted a relay request. For example, the server 1000 may select the first terminal 2000 and the second terminal 3000.

The server 1000 may serve as an intermediate for a communication connection between the selected first terminal 2000 and the selected second terminal 3000. For example, the server 1000 may serve as an intermediary for a video call connection or a text transmission and reception connection between the first terminal 2000 and the second terminal 3000. The server 1000 may transmit connection information regarding the first terminal 2000 to the second terminal 3000, and transmit connection information regarding the second terminal 3000 to the first terminal 2000.

The connection information regarding the first terminal 2000 may include an IP address and a port number of the first terminal 2000. The first terminal 2000 that has received connection information regarding the second terminal 3000 may try to connect to the second terminal 3000 by using the received connection information.

As the attempt by the first terminal 2000 to connect to the second terminal 3000 or the attempt by the second terminal 3000 to the first terminal 2000 succeed, a video call session between the first terminal 2000 and the second terminal 3000 may be established. The first terminal 2000 may transmit an image or sound to the second terminal 3000 through the video call session. The first terminal 2000 may encode the image or sound into a digital signal and transmit a result of the encoding to the second terminal 3000.

The first terminal 2000 may receive an image or sound that is encoded into a digital signal and decode the received image or sound.

The second terminal 3000 may transmit an image or sound to the first terminal 2000 through the video call session. In addition, the second terminal 3000 may receive an image or sound from the first terminal 2000 through the video call session. Accordingly, a user of the first terminal 2000 and a user of the second terminal 3000 may make a video call with each other.

The first terminal 2000 and the second terminal 3000 may be, for example, a desktop computer, a laptop computer, a smartphone, a smart tablet, a smart watch, a mobile terminal, a digital camera, a wearable device, or a portable electronic device, or the like. The first terminal 2000 and the second terminal 3000 may execute a program or application. The first terminal 2000 and the second terminal 3000 may be devices of the same type or different types.

FIG. 16 is a schematic flowchart of a landmark decomposition method according to an embodiment of the present disclosure. Referring to FIG. 16, the landmark decomposition method according to an embodiment of the present disclosure includes an operation of receiving a face image and landmark information (S210), an operation of estimating a transformation matrix (S220), calculating an expressional landmark (S230), and an operation of calculating an identity landmark (S240).

In operation S210, a face image of a first person and landmark information corresponding to the face image are received. Here, a landmark may be understood as a landmark of the face image (facial landmark). The landmark may indicate major elements of a face, for example, eyes, eyebrows, nose, mouth, or jawline.

In addition, the landmark information may include information about the position, size or shape of the major elements of the face. Also, the landmark information may include information about a color or texture of the major elements of the face.

The first person indicates an arbitrary person, and in operation S210, a face image of the arbitrary person and landmark information corresponding to the face image are received. The landmark information may be obtained through well-known technology, and any of well-known methods may be used to obtain the same. In addition, the present disclosure is not limited by the method of obtaining a landmark.

In operation S220, a transformation matrix corresponding to the landmark information is estimated. The transformation matrix may constitute the landmark information together with a preset unit vector. For example, first landmark information may be calculated by a product of the unit vector and a first transformation matrix. For example, second landmark information may be calculated by a product of the unit vector and a second transformation matrix.

The transformation matrix is a matrix converting high-dimensional landmark information into low-dimensional data, and may be used in principal component analysis (PCA). PCA is a dimension reduction method in which distribution of data is preserved as much as possible and new axes orthogonal to each other are searched for to convert variables of a high-dimensional space into variables of a low-dimensional space. In PCA, first, a hyperplane that is closest to data is searched for, and then the data is projected onto a hyperplane of a low dimension to reduce the data.

In PCA, a unit vector defining an ith axis is referred to as an ith principal component (PC), and by linearly combining these axes, high-dimensional data may be converted into low-dimensional data.

X=αY [Equation 7]

Here, X denotes landmark information of a high dimension, and Y denotes a principal component of a low dimension, and a denotes a transformation matrix.

As described above, the unit vector, that is, a principal component, may be determined in advance. Accordingly, when new landmark information is received, a transformation matrix corresponding thereto may be determined. Here, there may be a plurality of transformation matrices corresponding to one piece of landmark information.

Meanwhile, in operation S220, a learning model trained to estimate the transformation matrix may be used. The learning model may be understood as a model trained to estimate a PCA transformation matrix from an arbitrary face image and landmark information corresponding to the arbitrary face image.

The learning model may be trained to estimate the transformation matrix from face images of different people and landmark information corresponding to each of the face images. There may be several transformation matrices corresponding to one high-dimensional landmark information, and the learning model may be trained to output only one transformation matrix among the several transformation matrices.

The landmark information used as an input to the learning model may be obtained using a well-known method of extracting landmark information from a face image and visualizing the landmark information.

Thus, in operation S220, the face image of the first person and the landmark information corresponding to the face image are received as an input, and one transformation matrix is estimated therefrom and output.

Meanwhile, the learning model may be trained to classify landmark information into a plurality of semantic groups respectively corresponding to the right eye, the left eye, nose, and mouth, and to output PCA conversion coefficients respectively corresponding to the plurality of semantic groups.

Here, the semantic groups are not necessarily classified to correspond to the right eye, the left eye, nose, and mouth, but may also be classified to correspond to eyebrows, eyes, nose, mouth, and jawline or to correspond to eyebrows, the right eye, the left eye, nose, mouth, jawline, and ears. In operation S120, the landmark information is classified into semantic groups of a segmented unit according to the learning model, and a PCA conversion coefficient corresponding to the classified semantic groups may be estimated.

In operation S230, an expression landmark of the first person is calculated using the transformation matrix. Landmark information may be decomposed into a plurality of pieces of sub landmark information, and it is assumed in the present disclosure that the landmark information may be expressed as below.

I(c,t)=Iₘ+I_{id}(c)+Iₑₓₚ(c,t) [Equation 8]

where I(c,t) denotes landmark information in a t-th frame of a video containing person c; Iₘ denotes a mean facial landmark of humans; I_{id}(c) denotes a facial landmark of identity geometry of person c; Iₑₓₚ(c,t) denotes a facial landmark of expression geometry of person c in the t-th frame of the video containing person c.

That is, landmark information in a particular frame of a particular person may be expressed as a sum of mean landmark information of faces of all persons, identity landmark information of just the particular person, and facial expression and motion information of the particular person in the particular frame.

The mean landmark information may be defined by the equation as below, and may be calculated based on a large amount of videos that are collectable in advance.

$${l}_{m} = \frac{1}{T} {\sum }_{c} {\sum }_{t} l ( c , t ) \qquad [ Equation 9 ]$$

where T denotes the entire number of frames of a video, and thus, Iₘ denotes a mean of landmarks (I(c,t)) of all persons appearing in previously collected videos.

Meanwhile, the expression landmark may be calculated using the equation below.

$${l}_{exp} ( c , t ) = {\sum }_{k = 1}^{{n}_{exp}} {α}_{k} ( c , t ) {b}_{exp , k} = {b}^{T} α ( c , t ) \qquad [ Equation 10 ]$$

The above equation represents a result of performing PCA on each semantic group of person c. nₑₓₚ denotes a sum of expression bases of all semantic groups, and bₑₓₚ denotes an expression basis which is a basis of PCA, and a denotes a coefficient of PCA.

In other words, bₑₓₚ denotes an eigenvector described above, and an expression landmark of a high dimension may be defined by a combination of low-dimensional eigenvectors. Also, nₑₓₚ denotes a total number of expressions and motions that may be expressed by person c by the right eye, the left eye, nose, mouth, etc.

Thus, the expression landmark of the first person may be defined by a set of expression information regarding main parts of a face, that is, each of the right eye, the left eye, nose, and mouth. Also, there may be αₖ(c,t) corresponding to each eigenvector.

The learning model described above may be trained to estimate a PCA coefficient α(c,t) by using, as an input, a picture x(c,t) and landmark information I(c,t) of person c whose landmark information is to be decomposed, as shown in Equation 8. Through such learning, the learning model may estimate a PCA coefficient from an image of a particular person and landmark information corresponding thereto, and may estimate the low-dimensional eigenvector.

When applying a trained neural network, a PCA transformation matrix is estimated by using a picture x(c′,t) and landmark information I(c′,t) of person c′ whose landmark is to be decomposed, as an input to a neural network. Here, a value obtained from learning data may be used as bₑₓₚ, and an expression landmark may be estimated as below by using a predicted (estimated) PCA coefficient and bₑₓₚ.

Îₑₓₚ(c,t)=bₑₓₚ^{T}\hat{α}(c,t) [Equation 11]

Here, Îₑₓₚ(c,t) denotes an estimated expression landmark, \hat{α}(c,t) denotes an estimated PCA transformation matrix.

In operation S240, an identity landmark of the first person is calculated using the expression landmark. As described with reference to Equation 8, landmark information may be defined as a sum of mean landmark information, identity landmark information, and expression landmark information, and the expression landmark information may be estimated through Equation 11 in operation S230.

Thus, the identity landmark may be calculated as below.

Î_{id}(c)=I(c,t)−Iₘ−Îₑₓₚ(c,t) [Equation 12]

The above equation may be derived from Equation 8, and when the expression landmark is calculated in operation S230, an identity landmark may be calculated through Equation 12 in operation S240. The mean landmark information 6 may be calculated based on a large amount of videos that are collectable in advance.

Thus, when a face image of a person is given, landmark information may be obtained therefrom, and expression landmark information and identity landmark information may be calculated from the face image and the landmark information.

FIG. 17 is a schematic view illustrating a method of calculating a transformation matrix according to an embodiment of the present disclosure. Referring to FIG. 17, an artificial neural network receives a face image (input image) of a person as an input. As the above artificial neural network, some of the well-known artificial neural networks may be applied, and in an embodiment, the artificial neural network may be ResNet. ResNet is a type of a convolutional neural network (CNN), and the present disclosure is not limited to a particular type of artificial neural networks.

Multi Layer Perceptron (MLP) is a type of an artificial neural network in which several layers of Perceptron are stacked to overcome the shortcomings of a single-layer Perceptron. Referring to FIG. 17, an MLP receives an output of the artificial neural network and landmark information corresponding to the face image as an input. Also, the MLP outputs a transformation matrix.

In FIG. 17, it may also be understood that the artificial neural network and the MLP as a whole constitute one trained artificial neural network.

When the transformation matrix is estimated through the trained artificial neural network, as described above with reference to FIG. 16, expression landmark information and identity landmark information may be calculated. The landmark decomposition method according to the present disclosure may also apply to a case where there are only a very small number of face images or there is a face image of only one frame.

The trained artificial neural network is trained to estimate a low-dimensional eigenvector and a conversion coefficient from a large number of face images and landmark information corresponding to the face images, and the artificial neural network trained in this manner may estimate the eigenvector and the conversion coefficient even when just a face image of one frame is given.

When an expression landmark and an identity landmark of an arbitrary person are decomposed using the above-described method, the quality of face image processing techniques such as face reenactment, face classification, face morphing, or the like may be improved.

In the face reenactment technique, when a target face and a driver face are given, a face image or picture is composed, in which a motion of the driver face is emulated but the identity of the target face is preserved.

In the face morphing technique, when a face image or picture of each of person 1 and person 2 are given, a face image or picture of a third person in which the identities of person 1 and person 2 are preserved is composed. In a traditional morphing algorithm, a key point of a face is searched for, and then the face is divided into triangular or quadrangular pieces that do not overlap each other with respect to the key point. Thereafter, the pictures of person 1 and person 2 are combined to compose a picture of the third person, and because positions of key points of person 1 and person 2 are different from each other, when the picture of the third person is made by combining the pictures of person 1 and person 2 pixel-wise, a great degree of incompatibility may be sensed. As the conventional face morphing technique does not distinguish characteristics due emotion, such as the characteristics of outer appearance or facial expression of an object, the quality of a morphing result may be low.

According to the landmark decomposition method of the present disclosure, since expression landmark information and identity landmark information may be respectively decomposed from one piece of landmark information, the landmark decomposition method may contribute to improving a result of a face image processing technique using facial landmarks. In particular, according to the landmark decomposition method of the present disclosure, landmarks may be decomposed also when a very small amount of face image data is given, and thus, the landmark decomposition method of the present disclosure may be highly useful.

FIG. 18 is a schematic diagram illustrating a landmark decomposition apparatus according to an embodiment of the present disclosure. Referring to FIG. 18, a landmark decomposition apparatus 5000 according to an embodiment of the present disclosure includes a receiver 5100, a transformation matrix estimator 5200, and a calculator 5300.

The receiver 5100 receives a face image of a first person and landmark information corresponding to the face image. Here, a landmark refers to a landmark of the face (facial landmark), and may be understood as a concept encompassing major elements of a face, for example, eyes, eyebrows, nose, mouth, jawline, etc.

In addition, the landmark information may include information about the position, size or shape of the major elements of the face. Also, the landmark information may include information about a color or texture of the major elements of the face.

The first person denotes an arbitrary person, and the receiver 5100 receives a face image of the arbitrary person and landmark information corresponding to the face image. The landmark information may be obtained through well-known technology, any of well-known methods may be used to obtain the same. In addition, the present disclosure is not limited by the method of obtaining a landmark.

The transformation matrix estimator 5200 estimates a transformation matrix corresponding to the landmark information. The transformation matrix may constitute the landmark information together with a preset unit vector. For example, first landmark information may be calculated by a product of the unit vector and a first transformation matrix. For example, second landmark information may be calculated by a product of the unit vector and a second transformation matrix.

The transformation matrix is a matrix converting high-dimensional landmark information into low-dimensional data, and may be used in principal component analysis (PCA). PCA is a dimension reduction method in which distribution of data is preserved as much as possible and new axes orthogonal to each other is searched for to convert variables of a high-dimensional space into variables of a low-dimensional space. In PCA, first, a hyperplane that is closest to data is searched for, and then the data is projected onto a hyperplane of a low dimension to reduce the data.

In PCA, a unit vector defining an ith axis is referred to as an ith principal component (PC), and by linearly combining these axes, high-dimensional data may be converted into low-dimensional data.

As described above, the unit vector, that is, a principal component, may be determined in advance. Accordingly, when new landmark information is received, a transformation matrix corresponding thereto may be determined. Here, a there may be a plurality of transformation matrices corresponding to one piece of landmark information.

Meanwhile, the transformation matrix estimator 5200 may use a learning model trained to estimate the transformation matrix. The learning model may be understood as a model trained to estimate a PCA transformation matrix from an arbitrary face image and landmark information corresponding to the arbitrary face image.

The learning model may be trained to estimate the transformation matrix from face images of different people and landmark information corresponding to each of the face images. There may be several transformation matrices corresponding to one high-dimensional landmark information, and the landmark information may be trained to output only one transformation matrix among the several transformation matrices.

The landmark information used as an input to the learning model may be obtained using a well-known method of extracting landmark information from a face image and visualizing the landmark information.

Thus, the transformation matrix estimator 5200 may receive, as an input, the face image of the first person and landmark information corresponding to the face image, and estimate one transformation matrix from the face image and output the transformation matrix.

Meanwhile, the learning model may be trained to classify landmark information into a plurality of semantic groups respectively corresponding to the right eye, the left eye, nose, and mouth, and to output PCA conversion coefficients respectively corresponding to the plurality of semantic groups.

Here, the semantic groups are not necessarily classified to correspond to the right eye, the left eye, nose, and mouth, but may also be classified to correspond to eyebrows, eyes, nose, mouth, and jawline or to correspond to eyebrows, the right eye, the left eye, nose, mouth, jawline, and ears. The transformation matrix estimator 5200 may classify the landmark information into semantic groups of a segmented unit according to the learning model, and estimate a PCA conversion coefficient corresponding to the classified semantic groups.

The calculator 5300 calculates an expression landmark of the first person by using the transformation matrix, and calculate an identity landmark of the first person by using the expression landmark. Landmark information may be decomposed into a plurality of pieces of sub landmark information, for example, into mean landmark information, identity landmark information, and expression landmark information.

That is, landmark information in a particular frame of a particular person may be expressed as a sum of mean landmark information of faces of all persons, identity landmark information of the particular person, and facial expression and motion information of the particular person in the particular frame.

The mean landmark information may be defined by the equation as below, and may be calculated based on a large amount of videos that are collectable in advance.

The learning model described above may be trained to estimate a PCA coefficient α(c,t) by using, as an input, a picture x(c,t) and landmark information I(c,t) of person c whose landmark information is to be decomposed, as shown in Equation 8. Through such learning, the learning model may estimate a PCA coefficient from an image of a particular person and landmark information corresponding thereto, and may estimate the low-dimensional eigenvector.

When applying a trained neural network, a PCA transformation matrix is estimated by using a picture x(c′,t) and landmark information I(c,t) of person c′ whose landmark is to be decomposed, as an input to a neural network. Here, a value obtained from learning data may be used as bₑₓₚ, and an expression landmark may be estimated as in Equation 11 by using a predicted (estimated) PCA coefficient and bₑₓₚ.

Meanwhile, as described with reference to Equation 8, landmark information may be defined as a sum of mean landmark information, identity landmark information, and expression landmark information, and the expression landmark information may be estimated through Equation 11 in operation S230.

Accordingly, the identity landmark may be calculated as in Equation 12, and when a face image of an arbitrary person is given, landmark information may be obtained therefrom, and expression landmark information and identity landmark information may be calculated from the face image and the landmark information.

FIG. 19 is an exemplary view illustrating a method of reenacting a face by using the present disclosure. Referring to FIG. 19, a target image 4100 and a driver image 4200 are illustrated, and the target image 4100 may reenact an image corresponding to the driver image 4200.

A reenacted image 4300 has the characteristics of the target image 4100, but a facial expression thereof corresponds to the driver image 4200. That is, the reenacted image 4300 has an identity landmark of the target image 4100, but the expression landmark has features corresponding to the driver image 4200.

Thus, for natural reenactment of a face, it is important to appropriately decompose an identity landmark and an expression landmark from one landmark.

FIG. 20 schematically illustrates an image transformation apparatus according to the present disclosure and an environment in which an image transformation method according to the present disclosure operates. Referring to FIG. 20, an environment in which a first terminal 6000 and a second terminal 7000 operate may include a server 10000 and the first terminal 6000 and the second terminal 7000 that are connected to the server 10000. For convenience of description, only two terminals, that is, the first terminal 6000 and the second terminal 7000, are illustrated in FIG. 20, but two or more terminals may also be included. Regarding further terminals that may be added here, except for details to be particularly mentioned, the description regarding the first terminal 6000 and the second terminal 7000 may apply.

The server 10000 may be connected to a communication network. The server 10000 may be connected to other external devices through the communication network. The server 10000 may transmit data to another connected device or receive data from the other device.

The communication network connected to the server 10000 may include a wired communication network, a wireless communication network or a complex communication network. A communication network may include mobile communication networks such as 3G, LTE, or LTE-A. A communication network may include a wired or wireless communication network such as Wi-Fi, UMTS/GPRS, or Ethernet. A communication network may include short-range communication networks such as Magnetic Secure Transmission) (MST), Radio Frequency Identification (RFID), Near Field Communication (NFC), ZigBee, Z-Wave, Bluetooth, Bluetooth Low Energy (BLE), or Infrared (IR) communication), or the like. A communication network may include a local area network (LAN), a metropolitan area network (MAN), or a wide area network (WAN).

The server 10000 may include data from at least one of the first terminal 6000 and the second terminal 7000. The server 10000 may perform operation by using data received from at least one of the first terminal 6000 and the second terminal 7000. The server 10000 may transmit a result of the operation to at least one of the first terminal 6000 and the second terminal 7000.

The server 10000 may receive a relay request from at least one terminal from among the first terminal 6000 and the second terminal 7000. The server 10000 may select a terminal that has transmitted a relay request. For example, the server 10000 may select the first terminal 6000 and the second terminal 7000.

The server 10000 may serve as an intermediate for a communication connection between the selected first terminal 6000 and the selected second terminal 7000. For example, the server 10000 may serve as an intermediary for a video call connection or a text transmission and reception connection between the first terminal 6000 and the second terminal 7000. The server 10000 may transmit connection information regarding the first terminal 6000 to the second terminal 7000, and transmit connection information regarding the second terminal 7000 to the first terminal 6000.

The connection information regarding the first terminal 6000 may include an IP address and a port number of the first terminal 6000. The first terminal 6000 that has received connection information regarding the second terminal 7000 may try to connect to the second terminal 7000 by using the received connection information.

As the attempt by the first terminal to connect to the second terminal 7000 or the attempt by the second terminal 7000 to the first terminal 6000 succeed, a video call session between the first terminal 6000 and the second terminal 7000 may be established. The first terminal 6000 may transmit an image or sound to the second terminal 7000 through the video call session. The first terminal 6000 may encode the image or sound into a digital signal and transmit a result of the encoding to the second terminal 7000.

In addition, the first terminal 6000 may receive an image or sound from the second terminal 7000 through the video call session. The first terminal 6000 may receive an image or sound that is encoded into a digital signal and decode the received image or sound.

The second terminal 7000 may transmit an image or sound to the first terminal 6000 through the video call session. In addition, the second terminal 7000 may receive an image or sound from the first terminal 6000 through the video call session. Accordingly, a user of the first terminal 6000 and a user of the second terminal 7000 may make a video call with each other.

The first terminal 6000 and the second terminal 7000 may be, for example, a desktop computer, a laptop computer, a smartphone, a smart tablet, a smart watch, a mobile terminal, a digital camera, a wearable device, or a portable electronic device, or the like. The first terminal 6000 and the second terminal 7000 may execute a program or application. The first terminal 6000 and the second terminal 7000 may be devices of the same type or different types.

FIG. 21 is a schematic flowchart of an image transformation method according to an embodiment of the present disclosure.

Referring to FIG. 21, the image transformation method according to an embodiment of the present disclosure includes operation of obtaining landmark information of a face of a user (S2100), operation of generating a user feature map (S2200), operation of generating a target feature map (S2300), operation of generating a mixed feature map (S2400), and operation of generating a reenacted image (S2500).

In operation S2100, landmark information is obtained from a face image of a user. The landmark denotes face parts that characterize the face of the user, and may include, for example, eyes, eyebrows, nose, mouth, ears, or jawline or the like of the user. In addition, the landmark information may include information about the position, size or shape of the major elements of the face of the user. In addition, the landmark information may include information about a color or texture of the major elements of the face of the user.

The user may denote an arbitrary user who uses a terminal on which the image transformation method according to the present disclosure is performed. In operation S2100, the face image of the user is received and landmark information corresponding to the face image is obtained. The landmark information may be obtained through well-known technology, and any of well-known methods may be used to obtain the same. In addition, the present disclosure is not limited by the method of obtaining landmark information.

In operation S2200, a transformation matrix corresponding to the landmark information may be estimated. The transformation matrix may constitute the landmark information together with a preset unit vector. For example, first landmark information may be calculated by a product of the unit vector and a first transformation matrix. For example, second landmark information may be calculated by a product of the unit vector and a second transformation matrix.

The transformation matrix is a matrix converting high-dimensional landmark information into low-dimensional data, and may be used in principal component analysis (PCA). PCA is a dimension reduction method in which distribution of data is preserved as much as possible and new axes orthogonal to each other is searched for to convert variables of a high-dimensional space into variables of a low-dimensional space. In PCA, first, a hyperplane that is closest to data is searched for, and then the data is projected onto a hyperplane of a low dimension to reduce the data.

In PCA, a unit vector defining an ith axis is referred to as an ith principal component (PC), and by linearly combining these axes, high-dimensional data may be converted into low-dimensional data.

X=αY[Equation 13]

Here, X denotes landmark information of a high dimension, and Y denotes a principal component of a low dimension, and a denotes a transformation matrix.

As described above, the unit vector, that is, a principal component, may be determined in advance. Accordingly, when new landmark information is received, a transformation matrix corresponding thereto may be determined. Here, there may be a plurality of transformation matrices corresponding to one piece of landmark information.

Meanwhile, in operation S2100, a learning model trained to estimate the transformation matrix may be used. The learning model may be understood as a model trained to estimate a PCA transformation matrix from an arbitrary face image and landmark information corresponding to the arbitrary face image.

The learning model may be trained to estimate the transformation matrix from face images of different people and landmark information corresponding to each of the face images. There may be several transformation matrices corresponding to one high-dimensional landmark information, and the landmark information may be trained to output only one transformation matrix among the several transformation matrices.

The landmark information used as an input to the learning model may be obtained using a well-known method of extracting landmark information from a face image and visualizing the landmark information.

Thus, in operation S2100, the face image of the user and landmark information corresponding to the face image are received as an input, and one transformation matrix is estimated therefrom and output.

Meanwhile, the learning model may be trained to classify landmark information into a plurality of semantic groups respectively corresponding to the right eye, the left eye, nose, and mouth, and to output PCA conversion coefficients respectively corresponding to the plurality of semantic groups.

Here, the semantic groups are not necessarily classified to correspond to the right eye, the left eye, nose, and mouth, but may also be classified to correspond to eyebrows, eyes, nose, mouth, and jawline or to correspond to eyebrows, the right eye, the left eye, nose, mouth, jawline, and ears. In operation S2100, the landmark information is classified into semantic groups of a segmented unit according to the learning model, and a PCA conversion coefficient corresponding to the classified semantic groups may be estimated.

Meanwhile, an expression landmark of the user is calculated using the transformation matrix. Landmark information may be decomposed into a plurality of pieces of sub landmark information, and it is assumed in the present disclosure that the landmark information may be expressed as below.

I(c,t)=Iₘ+I_{id}(c)+Iₑₓₚ(c,t) [Equation 14]

where I(c,t) denotes landmark information in a t-th frame of a video containing person c; Iₘ denotes a mean facial landmark of humans; I_{id}(c) denotes a facial landmark of identity geometry of person c; Iₑₓₚ(c,t) denotes a facial landmark of expression geometry of person c in the t-th frame of the video containing person c.

That is, landmark information in a particular frame of a particular person may be expressed as a sum of mean landmark information of faces of all persons, identity landmark information of the particular person, and facial expression and motion information of the particular person in the particular frame.

The mean landmark information may be defined by the equation as below, and may be calculated based on a large amount of videos that are collectable in advance.

$${l}_{m} = \frac{1}{T} {\sum }_{c} {\sum }_{t} l ( c , t ) \qquad [ Equation 15 ]$$

where T denotes the entire number of frames of a video, and thus, Iₘ denotes a mean of landmarks (I(c,t)) of all persons appearing in previously collected videos.

Meanwhile, the expression landmark may be calculated using the equation below.

$${l}_{exp} ( c , t ) = {\sum }_{k = 1}^{{n}_{exp}} {α}_{k} ( c , t ) {b}_{exp , k} = {b}^{T} α ( c , t ) \qquad [ Equation 16 ]$$

The above equation represents a result of performing PCA on each semantic group of person c. nₑₓₚ denotes a sum of expression bases of all semantic groups, and bₑₓₚ denotes an expression basis which is a basis of PCA, and a denotes a coefficient of PCA.

In other words, bₑₓₚ denotes an eigenvector described above, and an expression landmark of a high dimension may be defined by a combination of low-dimensional eigenvectors. Also, nₑₓₚ denotes a total number of expressions and motions that may be expressed by person c by the right eye, the left eye, nose, mouth, etc.

Thus, the expression landmark of the first person may be defined by a set of expression regarding main parts of a face, that is, each of the right eye, the left eye, nose, and mouth. Also, there may be αₖ(c,t) corresponding to each eigenvector.

The learning model described above may be trained to estimate a PCA coefficient α(c,t) by using, as an input, a picture x(c,t) and landmark information I(c,t) of person c whose landmark information is to be decomposed, as shown in Equation 14. Through such learning, the learning model may estimate a PCA coefficient from an image of a particular person and landmark information corresponding thereto, and may estimate the low-dimensional eigenvector.

When applying a trained neural network, a PCA transformation matrix is estimated by using a picture x(c′,t) and landmark information I(c′,t) of person c′ whose landmark is to be decomposed, as an input to a neural network. Here, a value obtained from learning data may be used as bₑₓₚ, and an expression landmark may be estimated as below by using a predicted (estimated) PCA coefficient and bₑₓₚ.

Îₑₓₚ(c,t)=bₑₓₚ^{T}\hat{α}(c,t) [Equation 17]

Thereafter, by using the expression landmark, an identity landmark of the first person is calculated. As described with reference to Equation 14, landmark information may be defined as a sum of mean landmark information, identity landmark information, and expression landmark information, and the expression landmark information may be estimated through Equation 17.

Thus, the identity landmark may be calculated as below.

Î_{id}(c)=I(c,t)−Iₘ−Îₑₓₚ(c,t) [Equation 18]

The above equation may be derived from Equation 14, and when the expression landmark is calculated, an identity landmark may be calculated through Equation 18. The mean landmark information 6 may be calculated based on a large amount of videos that are collectable in advance.

Thus, when a face image of a person is given, landmark information may be obtained therefrom, and expression landmark information and identity landmark information may be calculated from the face image and the landmark information.

In operation S2200, a user feature map is generated from pose information of the face image of the user. The pose information may include motion information and facial expression information of the face image. Also, in operation S2200, the user feature map may be generated by inputting pose information corresponding to the face image of the user to an artificial neural network. Meanwhile, the pose information may be understood as corresponding to the expression landmark information obtained in operation S2100.

The user feature map generated in operation S2200 includes information expressing a facial expression that the user is making and characteristics of a motion of the face of the user. In addition, the artificial neural network used in operation S2200 may be a convolutional neural network (CNN) or other types of artificial neural networks.

In operation S2300, a face image of a target is received, and a target feature map and a pose-normalized target feature map are generated from style information and pose information corresponding to the face image of the target.

The target refers to a person to be transformed according to the present disclosure, and the user and the target may be different persons, but are not limited thereto. An reenacted image generated as a result of performing the present disclosure is transformed from the face image of the target, and may appear as a target imitating or copying a motion or facial expression of the user.

The target feature map includes information expressing a facial expression that the target is making and characteristics of a motion of the face of the target.

The pose-normalized target feature map may correspond to an output regarding the style information input to an artificial neural network. Alternatively, the pose-normalized target feature map may include information corresponding to distinct characteristics of the face of the target except for the pose information of the target.

Like the artificial neural network used in operation S2200, CNN may be used as the artificial neural network used in operation S2300, and a structure of the artificial neural network used in operation S2200 may be different from that of the artificial neural network used in operation S2300.

The style information refers to information indicating distinct characteristics of a person in a face of the person; for example, the style information may include innate features appearing on the face of the target, a size, shape, position or the like of landmarks, etc. Alternatively, the style information may include at least one of texture information, color information, and shape information corresponding to the face image of the target.

It will be understand that the target feature map includes data corresponding to expression landmark information obtained from the face image of the target, and the pose-normalized target feature map includes data corresponding to the identity landmark information obtained from the face image of the target.

In operation S2400, a mixed feature map is generated using the user feature map and the target feature map, and the mixed feature map may be generated by inputting the pose information of the face image of the user and the style information of the face image of the target, into an artificial neural network.

The mixed feature map may be generated to have pose information in which a landmark of the target corresponds to a landmark of the user.

Like the artificial neural network used in operation S2200 and operation S2300, CNN may be used as the artificial neural network used in operation S2400, and a structure of the artificial neural network used in operation S2400 may be different from that of the artificial neural network used in the previous operations.

In operation S2500, by using the mixed feature map and the pose-normalized target feature map, a reenacted image of the face image of the target is generated.

As described above, the pose-normalized target feature map includes data corresponding to identity landmark information obtained from the face image of the target, and the identity landmark information refers to information corresponding to distinct characteristics of a person, which are not relevant to expression information corresponding to motion information or facial expression information of that person.

When a motion of a target that naturally follows a motion of the user can be obtained through the mixed feature map generated in operation S2400, in operation S2500, the effect as if the target is actually moving by itself and making a facial expression by itself may be obtained by reflecting the distinct characteristics of the target.

FIG. 22 is an exemplary view of a result of performing an image transformation method according to an embodiment of the present disclosure. FIG. 22 illustrates a target image, a user image, and a reenacted image, and the reenacted image maintains the features of the face of the target but has the motion and facial expression of the face of the user.

When comparing the target image with the reenacted image of FIG. 22, the two images show the same person, and there are only difference in the facial expression. The eyes, nose, mouth, and hair style of the target image are identical to the eyes, nose, mouth, and hair style of the reenacted image.

Meanwhile, a facial expression of the person of the reenacted image is substantially the same as that of the user. For example, when the user on the user image is opening the mouth, the reenacted image has an image of the target opening the mouth. In addition, when the user on the user image is turning his or her head to the right or to the left, the reenacted image has an image of the target turning his or her head to the right or the left.

When receiving an image of a user that changes in real time and generating a reenacted image based on the received image, the reenacted image may change a target image according to motion and facial expression of the user that change in real time.

FIG. 23 is a schematic diagram illustrating an image transformation apparatus according to an embodiment of the present disclosure. Referring to FIG. 23, an image transformation apparatus 8000 according to an embodiment of the present disclosure includes a landmark obtainer 8100, a first encoder 8200, a second encoder 8300, a blender 84400, and a decoder 8500.

The landmark obtainer 8100 receives face images of a user and a target and obtains landmark information from each face image. The landmark denotes face parts that characterize the face of the user, and may include, for example, eyes, eyebrows, nose, mouth, ears, or jawline or the like of the user. In addition, the landmark information may include information about the position, size or shape of the major elements of the face of the user. In addition, the landmark information may include information about a color or texture of the major elements of the face of the user.

The user may denote an arbitrary user who uses a terminal on which the image transformation method according to the present disclosure is performed. The landmark obtainer 8100 receives the face image of the user and obtains landmark information corresponding to the face image. The landmark information may be obtained through well-known technology, and any of well-known methods may be used to obtain the same. In addition, the present disclosure is not limited by the method of obtaining landmark information.

The landmark obtainer 8100 may estimate a transformation matrix corresponding to the landmark information. The transformation matrix may constitute the landmark information together with a preset unit vector. For example, first landmark information may be calculated by a product of the unit vector and a first transformation matrix. For example, second landmark information may be calculated by a product of the unit vector and a second transformation matrix.

The transformation matrix is a matrix converting high-dimensional landmark information into low-dimensional data, and may be used in principal component analysis (PCA). PCA is a dimension reduction method in which distribution of data is preserved as much as possible and new axes orthogonal to each other is searched for to convert variables of a high-dimensional space into variables of a low-dimensional space. In PCA, first, a hyperplane that is closest to data is searched for, and then the data is projected onto a hyperplane of a low dimension to reduce the data.

In PCA, a unit vector defining an ith axis is referred to as an ith principal component (PC), and by linearly combining these axes, high-dimensional data may be converted into low-dimensional data.

Meanwhile, the landmark obtainer 31 may use a learning model trained to estimate the transformation matrix. The learning model may be understood as a model trained to estimate a PCA transformation matrix from an arbitrary face image and landmark information corresponding to the arbitrary face image.

The learning model may be trained to estimate the transformation matrix from face images of different people and landmark information corresponding to each of the face images. There may be several transformation matrices corresponding to one high-dimensional landmark information, and the landmark information may be trained to output only one transformation matrix among the several transformation matrices.

The landmark information used as an input to the learning model may be obtained using a well-known method of extracting landmark information from a face image and visualizing the landmark information.

Thus, the landmark obtainer 8100 receives the face image of the user and landmark information corresponding to the face image as an input, and estimates one transformation matrix therefrom and outputs the same.

Meanwhile, the learning model may be trained to classify landmark information into a plurality of semantic groups respectively corresponding to the right eye, the left eye, nose, and mouth, and to output PCA conversion coefficients respectively corresponding to the plurality of semantic groups.

Here, the semantic groups are not necessarily classified to correspond to the right eye, the left eye, nose, and mouth, but may also be classified to correspond to eyebrows, eyes, nose, mouth, and jawline or to correspond to eyebrows, the right eye, the left eye, nose, mouth, jawline, and ears. The landmark obtainer 8100 may classify the landmark information into semantic groups of a segmented unit according to the learning model, and estimate a PCA conversion coefficient corresponding to the classified semantic groups.

Meanwhile, an expression landmark of the user may be calculated using the transformation matrix. Landmark information may be decomposed into a plurality of pieces of sub landmark information, and in the present disclosure, the landmark information is defined to be a sum of mean facial landmark of humans, facial landmark of identity geometry of a person, and facial landmark of expression geometry of the person.

That is, landmark information in a particular frame of a particular person may be expressed as a sum of mean landmark information of faces of all persons, identity landmark information of the particular person, and facial expression and motion information of the particular person in the particular frame.

Meanwhile, the expression landmark corresponds to pose information of the face image of the user, and the identity landmark corresponds to style information of the face image of the target.

In sum, the landmark obtainer 8100 may receive the face image of the user and the face image of the target and respectively generate, from the face images, a plurality of pieces of landmark information including expression landmark information and identity landmark information.

The first encoder 8200 generates user feature map from the pose information of the face image of the user. The pose information corresponds to the expression landmark information and may include motion information and facial expression information of the face images. In addition, the first encoder 8200 may input pose information corresponding to the face image of the user into an artificial neural network to generate the user feature map.

The user feature map generated by the first encoder 8200 includes information expressing a facial expression that the user is making and characteristics of a motion of the face of the user. In addition, the artificial neural network used by the first encoder 8200 may be a convolutional neural network (CNN) or other types of artificial neural networks.

The second encoder 8300 generates a target feature map and a pose-normalized target feature map from style information and pose information of the face image of the target.

The target refers to a person to be transformed according to the present disclosure, and the user and the target may be different persons, but are not limited thereto. An reenacted image generated as a result of performing the present disclosure is transformed from the face image of the target, and may appear as a target imitating or copying a motion or facial expression of the user.

The target feature map generated by the second encoder 8300 may be understood to be data corresponding to the user feature map generated by the first encoder 8200, and includes information expressing the features of a facial expression that the target is making and a motion of the face of the target.

The pose-normalized target feature map may correspond to an output regarding the style information input to an artificial neural network. Alternatively, the pose-normalized target feature map may include information corresponding to distinct characteristics of the face of the target except for the pose information of the target.

Like the artificial neural network used by the first encoder 8200, CNN may be used as the artificial neural network used by the second encoder 8300, and a structure of the artificial neural network used by the first encoder 8200 may be different from that of the artificial neural network used by the second encoder 8300.

The style information refers to information indicating distinct characteristics of a person in a face of the person; for example, the style information may include innate features appearing on the face of the target, a size, shape, position or the like of landmarks, etc. Alternatively, the style information may include at least one of texture information, color information, and shape information corresponding to the face image of the target.

It will be understand that the target feature map includes data corresponding to expression landmark information obtained from the face image of the target, and the pose-normalized target feature map includes data corresponding to the identity landmark information obtained from the face image of the target.

The blender 8400 may generate a mixed feature map by using the user feature map and the target feature map, and generate the mixed feature map by inputting the pose information of the face image of the user and the style information of the face image of the target, into an artificial neural network.

The mixed feature map may be generated to have pose information in which a landmark of the target corresponds to a landmark of the user. Like the artificial neural network used by the first encoder 32 and the second encoder 8300, CNN may be used as the artificial neural network used by the blender 8400, and a structure of the artificial neural network used by the blender 8400 may be different from that of the artificial neural network used by the first encoder 8200 or the second encoder 8300.

The user feature map and the target feature map that are input to the blender 8400 respectively include landmark information of the face of the user and landmark information of the face of the target, and the blender 8400 may perform an operation of matching the landmark of the face of the user to the landmark of the face of the target such that the distinct characteristics of the face of the target are maintained, while generating the face of the target corresponding to the motion and facial expression of the face of the user.

For example, to control a motion of the face of the target according to a motion of the face of the user, it may be understood that landmarks of the user such as the eyes, eyebrows, nose, mouth, jawline or the like are respectively linked with landmarks of the target such as the eyes, eyebrows, nose, mouth, jawline or the like.

Alternatively, to control a facial expression of the face of the target according to a facial expression of the face of the user, landmarks of the user such as the eyes, eyebrows, nose, mouth, jawline or the like may be respectively linked with landmarks of the target such as the eyes, eyebrows, nose, mouth, jawline or the like.

By using the mixed feature map and the pose-normalized target feature map, the decoder 8500 generates a reenacted image of the face image of the target.

As described above, the pose-normalized target feature map includes data corresponding to identity landmark information obtained from the face image of the target, and the identity landmark information refers to information corresponding to distinct characteristics of a person, which are not relevant to expression information corresponding to motion information or facial expression information of that person.

When a motion of a target that naturally follows a motion of the user can be obtained through the mixed feature map generated using the blender 8400, the decoder 8500 may obtain the effect as if the target is actually moving by itself and making a facial expression by itself by reflecting the distinct characteristics of the target.

FIG. 24 is a schematic diagram illustrating a configuration of a landmark obtainer according to an embodiment of the present disclosure. Referring to FIG. 24, the landmark obtainer according to an embodiment of the present disclosure may include an artificial neural network, and the artificial neural network receives a face image (input image) of a person as an input. As the above artificial neural network, some of the well-known artificial neural networks may be applied, and in an embodiment, the artificial neural network may be ResNet. ResNet is a type of a convolutional neural network (CNN), and the present disclosure is not limited to a particular type of artificial neural networks.

Multi Layer Perceptron (MLP) is a type of an artificial neural network in which several layers of Perceptron are stacked to overcome the shortcomings of a single-layer Perceptron. Referring to FIG. 24, an MLP receives an output of the artificial neural network and landmark information corresponding to the face image as an input. Also, the MLP outputs a transformation matrix. Meanwhile, it may be understood that the artificial neural network and the MLP as a whole constitute one trained artificial neural network.

When the transformation matrix is estimated through the trained artificial neural network, as described above with reference to FIG. 23, expression landmark information and identity landmark information may be calculated. The image transformation apparatus according to the present disclosure may also apply to a case where there are only a very small number of face images or there is a face image of only one frame.

The trained artificial neural network is trained to estimate a low-dimensional eigenvector and a conversion coefficient from a large number of face images and landmark information corresponding to the faces images, and the artificial neural network trained in this manner may estimate the eigenvector and the conversion coefficient even when just a face image of one frame is given.

When an expression landmark and an identity landmark of an arbitrary person are decomposed using the above-described method, the quality of face image processing techniques such as face reenactment, face classification, face morphing, or the like may be improved.

FIG. 25 is a schematic diagram illustrating a second encoder according to an embodiment of the present disclosure.

Referring to FIG. 25, the second encoder 33 according to an embodiment of the present disclosure may employ a U-Net structure. A U-Net refers to a U-shaped network and basically performs a segmentation function and has a symmetric shape.

f_{y} denotes a normalized flow map used when normalizing a target feature map, and T denotes a warping function performing warping. Also, Sₖ and j=1 . . . n_{y} respectively denote a target feature map encoded in each convolutional layer.

The second encoder 8300 receives a rendered target landmark and a rendered target image as an input and generates, therefrom, an encoded target feature map and an encoded normalized flow map f_{y}. Also, by performing a warping function by using the generated target feature map Sj and the generated normalized flow map f_{y} as an input, a warped target feature map is generated.

Here, the warped target feature map may be understood to be the same as the pose-normalized target feature map described above. Accordingly, the warping function T may be understood to be a function that generates data consisting of only style information of the target itself, that is, only identity landmark information, without expression landmark information of the target.

FIG. 26 is a schematic diagram illustrating a structure of a blender according to an embodiment of the present disclosure.

As described above, the blender 8400 generates a mixed feature map from a user feature map and a target feature map, and may generate the mixed feature map by inputting, into an artificial neural network, pose information of the face image of the user and the style information of the face image of the target.

In FIG. 26, one user feature map and three target feature maps are illustrated, but there may be also one target feature map or two or three or more target feature maps. Also, a small area in each feature map illustrated in FIG. 25 indicates information regarding an arbitrary landmark, and each indicates information about the same landmark.

The user feature map and the target feature map that are input to the blender 8400 respectively include landmark information of the face of the user and landmark information of the face of the target, and the blender 8400 may perform an operation of matching the landmark of the face of the user to the landmark of the face of the target such that the distinct characteristics of the face of the target are maintained, while generating the face of the target corresponding to the motion and facial expression of the face of the user.

For example, to control a motion of the face of the target according to a motion of the face of the user, it may be understood that landmarks of the user such as the eyes, eyebrows, nose, mouth, jawline or the like are respectively linked with landmarks of the target such as the eyes, eyebrows, nose, mouth, jawline or the like.

Alternatively, to control a facial expression of the face of the target according to a facial expression of the face of the user, landmarks of the user such as the eyes, eyebrows, nose, mouth, jawline or the like may be respectively linked with landmarks of the target such as the eyes, eyebrows, nose, mouth, jawline or the like.

In addition, for example, eyes may be searched from the user feature map and then eyes may be searched from the target feature map, and a mixed feature map may be generated such that the eyes of the target feature map follows a movement of the eyes of the user feature map. Substantially the same operation may be performed on other landmarks by using the blender 8400.

FIG. 27 is a schematic diagram illustrating a decoder according to an embodiment of the present disclosure.

Referring to FIG. 27, the decoder 8500 according to an embodiment of the present disclosure applies expression landmark information of a user to a target image by using, as an input, the pose-normalized target feature map generated using the second encoder 8300 and the mixed feature map z_{xy} generated using the blender 8400.

In FIG. 27, data input to each block of the decoder 8500 indicates the pose-normalized target feature map generated using the second encoder 8300, and fᵤ indicates a flow map through which expression landmark information of the user is applied to the pose-normalized target feature map.

In addition, a warp-alignment block of the decoder 8500 performs a warping function by using an output (u) of a previous block of the decoder 8500 and the pose-normalized target feature map as an input. The warping function performed in the decoder 8500 is to generate a reenacted image conforming to a motion and pose of the user while maintaining the distinct characteristics of the target, and is different from the warping function performed in the second encoder 8300.

Meanwhile, a moving image may be generated by the embodiments described above with reference to FIGS. 1 to 27. For example, as described above with reference to FIGS. 5A to 6B, a moving image may be generated by converting an input static image.

Alternatively, based on an image conversion template, a static image input may be converted into a moving image. The image conversion template may include a plurality of frames, and each frame may be a static image. For example, a plurality of intermediate images (i.e., a plurality of static images) may be generated by applying each of the plurality of frames to an input static image. And, the moving image may be generated by combining the generated intermediate images.

Alternatively, a moving image may be generated by converting an input moving image. In this case, each of the plurality of first static images (frames) included in the input moving image is converted into second static images, respectively, and the second static images are combined to generate the moving image.

The embodiments described above with reference to FIGS. 1 to 27 may be implemented by the contents to be described below. For example, at least some of the contents to be described below may be applied to at least one of the above-described embodiments with reference to FIGS. 1 to 27. In addition, when the meaning of the term to be described below and the meaning of the term described with reference to FIGS. 1 to 27 are the same or similar to each other, it may be understood as terms referring to the same object. In addition, when the content to be described below and the content described above with reference to FIGS. 1 to 27 are the same or similar to each other, it may be understood that the content is the same. In addition, the content to be described below may be included in the content of the paper entitled “MarioNETte: Few-shot Face Reenactment Preserving Identity of Unseen Targets”.

When there is a mismatch between the target identity and the driver identity, face reenactment suffers severe degradation in the quality of the result, especially in a few-shot setting. The identity preservation problem, where the model loses the detailed information of the target leading to a defective output, is the most common failure mode. The problem has several potential sources such as the identity of the driver leaking due to the identity mismatch, or dealing with unseen large poses.

To overcome such problems, we introduce components that address the mentioned problem: image attention block, target feature alignment, and landmark transformer. Through attending and warping the relevant features, the proposed architecture, called MarioNETte, produces high-quality reenactments of unseen identities in a few-shot setting. In addition, the landmark transformer dramatically alleviates the identity preservation problem by isolating the expression geometry through landmark disentanglement. Comprehensive experiments are performed to verify that the proposed framework can generate highly realistic faces, outperforming all other baselines, even under a significant mismatch of facial characteristics between the target and the driver.

Given a target face and a driver face, face reenactment aims to synthesize a reenacted face which is animated by the movement of a driver while preserving the identity of the target.

Many approaches make use of generative adversarial net-works (GAN) which have demonstrated a great success in image generation tasks. Xu et al.; Wu et al. (2017; 2018) achieved high-fidelity face reenactment results by exploiting CycleGAN (Zhu et al. 2017). However, the CycleGAN-based approaches require at least a few minutes of training data for each target and can only reenact predefined identities, which is less attractive in-the-wild where a reenactment of unseen targets cannot be avoided.

The few-shot face reenactment approaches, therefore, try to reenact any unseen targets by utilizing operations such as adaptive instance normalization (AdaIN) (Zakharov et al. 2019) or warping module (Wiles, Koepke, and Zisserman 2018; Siarohin et al. 2019). However, current state-of-the-art methods suffer from the problem we call identity preservation problem: the inability to preserve the identity of the target leading to defective reenactments. As the identity of the driver diverges from that of the target, the problem is exacerbated even further.

Examples of flawed and successful face reenactments, generated by previous approaches and the proposed model, respectively, are illustrated in FIGS. 28A to 28C. The failures of previous approaches, for the most part, can be broken down into three different modes:

1. Neglecting the identity mismatch may lead to an identity of the driver interfere with the face synthesis such that the generated face resembles the driver (FIG. 28A).

2. Insufficient capacity of the compressed vector representation (e.g., AdaIN layer) to preserve the information of the target identity may lead the produced face to lose the detailed characteristics (FIG. 28B).

3. Warping operation incurs a defect when dealing with large poses (FIG. 28C).

We propose a framework called MarioNETte, which aims to reenact the face of unseen targets in a few-shot manner while preserving the identity without any fine-tuning. We adopt image attention block and target feature alignment, which allow MarioNETte to directly inject features from the target when generating image. In addition, we propose a novel landmark transformer which further mitigates the identity preservation problem by adjusting for the identity mismatch in an unsupervised fashion. Our contributions are as follows:
We propose a few-shot face reenactment framework called MarioNETte, which preserves the target identity even in situations where the facial characteristics of the driver differs widely from those of the target. Utilizing image attention block, which allows the model to attend to relevant positions of the target feature map, together with target feature alignment, which includes multiple feature-level warping operations, proposed method improves the quality of the face reenactment under different identities.
We introduce a novel method of landmark transformation which copes with varying facial characteristics of different people. The proposed method adapts the landmark of a driver to that of the target in an unsupervised manner, thereby mitigating the identity preservation problem without any additional labeled data.
We compare the state-of-the-art methods when the target and the driver identities coincide and differ using VoxCeleb1 (Nagrani, Chung, and Zisserman 2017) and CelebV (Wu et al. 2018) dataset, respectively. Our experiments including user studies show that the proposed method outperforms the state-of-the-art methods.

MarioNETte Architecture

FIG. 29 illustrates the overall architecture of the proposed model. A conditional generator G generates the reenacted face given the driver x and the target images {yⁱ}_{i=1 . . . K}, and the discriminator D predicts whether the image is real or not.

The generator consists of following components:
The preprocessor P utilizes a 3D landmark detector (Bulat and Tzimiropoulos 2017) to extract facial keypoints and renders them to landmark image, yielding rₓ=P(x) and r_{y}ⁱ=P(yⁱ), corresponding to the driver and the target input respectively. Note that proposed landmark transformer is included in the preprocessor. Since we normalize the scale, translation and rotation of landmarks before using them in a landmark transformer, we utilize 3D landmarks instead of 2D ones.
The driver encoder Eₓ(rₓ) extracts pose and expression information from the driver input and produces driver feature map zₓ.
The target encoder E_{y}(y, r_{y}) adopts a U-Net architecture to extract style information from the target input and generates target feature map z y along with the warped target feature maps Ŝ.
The blender B(zₓ,{z_{y}ⁱ}_{i=1 . . . K}) receives driver feature map zₓ and target feature maps Z_{y}=[z_{y}¹, . . . z_{y}^{K}] to produce mixed feature map z_{xy}. Proposed image attention block is basic building block of the blender.
The decoder Q(z_{xy},{Ŝⁱ}_{i=1 . . . K}) utilizes warped target feature maps Ŝ and mixed feature map z_{xy} to synthesize reenacted image. The decoder improves quality of reenacted image exploiting proposed target feature alignment.

Image Attention Block

To transfer style information of targets to the driver, previous studies encoded target information as a vector and mixed it with driver feature by concatenation or AdaIN layers (Liu et al. 2019; Zakharov et al. 2019). However, encoding targets as a spatial-agnostic vector leads to losing spatial information of targets. In addition, these methods are absent of innate design for multiple target images, and thus, summary statistics (e.g. mean or max) are used to deal with multiple targets which might cause losing details of the target.

We suggest image attention block (FIG. 30) to alleviate aforementioned problem. The proposed attention block is inspired by the encoder-decoder attention of transformer (Vaswani et al. 2017), where the driver feature map acts as an attention query and the target feature maps act as attention memory. The proposed attention block attends to proper positions of each feature (red boxes in FIG. 30) while handling multiple target feature maps (i.e., Z_{y}).

Given driver feature map zₓ∈ [symbol] ^{h}^{ₓ}^{×w}^{ₓ}^{×c}^{ₓ} and target feature maps Z_{y}=[z_{y}¹, . . . , z_{y}^{K}]∈ [symbol] ^{h}^{ₓ}^{×w}^{ₓ}^{×c}^{ₓ}, the attention is calculated as follows:

Q=zₓW_{q}+PₓW_{qp}∈ [symbol] ^{h}^{ₓ}^{×w}^{ₓ}^{×c}^{ₓ}

K=Z_{y}Wₖ+P_{y}Wₖₚ∈ [symbol] ^{K×h}^{ₓ}^{×w}^{ₓ}^{×c}^{ₓ}

V=Z_{y}Wᵥ∈∈ [symbol] ^{k×h}^{ₓ}^{×w}^{ₓ}^{×c}^{ₓ} [Equation 19]

$$A ( Q , K , V ) = softmax ( \frac{f ( Q ) {f ( K )}^{T}}{\sqrt{{c}_{a}}} ) f ( V ) \qquad [ Equation 20 ]$$

where f: [symbol] ^{d}^{₁}^{× . . . ×d}^{ₖ}^{+c} → [symbol] ^{d}^{₁}^{× . . . ×d}^{ₖ}^{+c} is a flattening function, all W are linear projection matrices that map to proper number of channels at the last dimension, and Pₓ and P_{y} are sinusoidal positional encodings which encode the coordinate of feature maps. Finally, the output A(Q, K, V)∈ [symbol] ^{(h}^{ₓ}^{×w}^{ₓ}^{)×c}^{ₓ} is reshaped to [symbol] ^{h}^{ₓ}^{×w}^{ₓ}^{×c}^{ₓ}.

Instance normalization, residual connection, and convolution layer follow the attention layer to generate output feature map z_{xy}. The image attention block offers a direct mechanism of transferring information from multiple target images to the pose of driver.

Target Feature Alignment

The fine-grained details of the target identity can be preserved through the warping of low-level features (Siarohin et al. 2019). Unlike previous approaches that estimate a warping flow map or an affine transform matrix by computing the difference between keypoints of the target and the driver (Balakrishnan et al. 2018; Siarohin et al. 2018; Siarohin et al. 2019), we propose a target feature alignment (FIG. 31) which warps the target feature maps in two stages: (1) target pose normalization generates pose normalized target feature maps and (2) driver pose adaptation aligns normalized target feature maps to the pose of the driver. The two-stage process allows the model to better handle the structural disparities of different identities. The details are as follows:

1. Target pose normalization. In the target encoder E_{y}, encoded feature maps {Sⱼ}_{j=1 . . . n}_{_{y}} are processed into S={ [symbol] (S₁;f_{y}, . . . [symbol] (Sₙ_{_{y}};f_{y})} by estimated normalization flow map f_{y} of target and warping function [symbol] (\textcircled{1} in FIG. 31). The following warp-alignment block at decoder treats Ŝ in a target pose-agnostic manner.

2. Driver pose adaptation. The warp-alignment block in the decoder receives {Ŝⁱ}_{i=1 . . . K} and the output u of the previous block of the decoder. In a few-shot setting, we average resolution-compatible feature maps from different target images (i.e., Ŝⱼ=ΣᵢŜⱼⁱK). To adapt pose-normalized feature maps to the pose of the driver, we generate an estimated flow map of the driver fᵤ using 1×1 convolution that takes u as the input. Alignment by [symbol] (Ŝⱼ;fᵤ) follows (\textcircled{2} in FIG. 31). Then, the result is concatenated to u and fed into the following residual upsampling block.

Landmark Transformer

Large structural differences between two facial landmarks may lead to severe degradation of the quality of the reenactment. The usual approach to such a problem has been to learn a transformation for every identity (Wu et al. 2018) or by preparing a paired landmark data with the same expressions (Zhang et al. 2019). However, these methods are unnatural in a few-shot setting where we handle unseen identities, and moreover, the labeled data is hard to be acquired. To overcome this difficulty, we propose a novel landmark transformer which transfers the facial expression of the driver to an arbitrary target identity. The landmark transformer utilizes multiple videos of unlabeled human faces and is trained in an unsupervised manner.

Landmark Decomposition

Given video footages of different identities, we denote x(c,t) as the t-th frame of the c-th video, and I(c,t) as a 3D facial landmark. We first transform every landmark into a normalized landmark Ī(c,t) by normalizing the scale, translation, and rotation. Inspired by 3D morphable models of face (Blanz and Vetter 1999), we assume that normalized landmarks can be decomposed as follows:

Ī(c,t)=Īₘ+Ī_{id}(c)+Īₑₓₚ(c,t) [Equation 21]

where Īₘ is the average facial landmark geometry computed by taking the mean over all landmarks, Ī_{id}(c) denotes the landmark geometry of identity c, computed by Ī_{id}(c)=ΣₜĪ(c,t)/T_{c}−Īₘ where T_{c} is the number of frames of c-th video, and Īₑₓₚ(c,t) corresponds to the expression geometry of t-th frame. The decomposition leads to Īₑₓₚ(c,t)=Ī(c,t)−Īₘ−Ī_{id}(c).

Given a target landmark Ī(c_{y}, t_{y}) and a driver landmark Ī(cₓ, tₓ) we wish to generate the following landmark:

Ī(c_{c}→c_{y},tₓ)=Īₘ+Ī_{id}(c_{y})+Īₑₓₚ(cₓ,tₓ) [Equation 22]

i.e., a landmark with the identity of the target and the expression of the driver. Computing Ī_{id}(c_{y}) and Īₑₓₚ is possible if enough images of c_{y} are given, but in a few-shot setting, it is difficult to disentangle landmark of unseen identity into two terms.

Landmark Disentanglement

To decouple the identity and the expression geometry in a few-shot setting, we introduce a neural network to regress the coefficients for linear bases. Previously, such an approach has been widely used in modeling complex face geometries (Blanz and Vetter 1999). We separate expression landmarks into semantic groups of the face (e.g., mouth, nose and eyes) and perform PCA on each group to extract the expression bases from the training data:

$${\overline{l}}_{exp} ( c , t ) = {\sum }_{k = 1}^{{n}_{exp}} {α}_{k} ( c , t ) {b}_{exp , k} = {b}_{exp}^{T} α ( c , t ) \qquad [ Equation 23 ]$$

where b_{exp,k} and αₖ represent the basis and the corresponding coefficient, respectively.

The proposed neural network, a landmark disentangle M, estimates α(c,t) given an image x(c,t) and an landmark Ī(c,t). FIG. 32 illustrates the architecture of the landmark disentangler. Once the model is trained, the identity and the expression geometry can be computed as follows:

α̅(c,t)=M(x(c,t),Ī(c,t))

Īₑₓₚ(c,t)=λₑₓₚbₑₓₚ^{T}\hat{α}(c,t)

Ī_{id}(c)=Ī(c,t)−Īₘ−Īₑₓₚ(c,t) [Equation 24]

where λₘₐₓ is a hyperparameter that controls the intensity of the predicted expressions from the network. Image feature extracted by a ResNet-50 and the landmark, Ī(c,t)−Īₘ, are fed into a 2-layer MLP to predict \hat{α}(c,t).

During the inference, the target and the driver landmarks are processed according to Equation 24. When multiple target images are given, we take the mean value over all Ī_{id}(c_{y}). Finally, landmark transformer converts landmark as:

Ī(cₓ→c_{y},tₓ)=Īₘ+Ī_{id}(c_{y})+Īₑₓₜ(cₓ,tₓ) [Equation 25]

Denormalization to recover the original scale, translation, and rotation is followed by the rasterization that generates a landmark adequate for the generator to consume.

Experimental Setup

Datasets

We trained our model and the baselines using VoxCeleb1 (Nagrani, Chung, and Zisserman 2017), which contains 256×256 size videos of 1,251 different identities. We utilized the test split of VoxCeleb1 and CelebV (Wu et al. 2018) for evaluating self-reenactment and reenactment under a different identity, respectively. We created the test set by sampling 2,083 image sets from randomly selected 100 videos of VoxCeleb1 test split, and uniformly sampled 2,000 image sets from every identity from CelebV. The CelebV data includes the videos of five different celebrities of widely varying characteristics, which we utilize to evaluate the performance of the models reenacting unseen targets, similar to in-the-wild scenario. Further details of the loss function and the training method can be found at Supplementary Material A3 and A4.

Baselines

MarioNETte variants, with and without the landmark transformer (MarioNETte+LT and MarioNETte, respectively), are compared with state-of-the-art models for few-shot face reenactment. Details of each baseline are as follows:
X2Face (Wiles, Koepke, and Zisserman 2018). X2face utilizes direct image warping. We used the pre-trained model provided by the authors, trained on VoxCeleb1.
Monkey-Net (Siarohin et al. 2019). Monkey-Net adopts feature-level warping. We used the implementation provided by the authors. Due to the structure of the method, Monkey-Net can only receive a single target image.
NeuralHead (Zakharov et al. 2019). NeuralHead exploits AdaIN layers. Since a reference implementation is absent, we made an honest attempt to reproduce the results. Our implementation is a feed-forward version of their model (NeuralHead-FF) where we omit the meta-learning as well as fine-tuning phase, because we are interested in using a single model to deal with multiple identities.

Metrics

We compare the models based on the following metrics to evaluate the quality of the generated images. Structured similarity (SSIM) (Wang et al. 2004) and peak signal-to-noise ratio (PSNR) evaluate the low-level similarity between the generated image and the ground-truth image. We also report the masked-SSIM (M-SSIM) and masked PSNR (M-PSNR) where the measurements are restricted to the facial region.

In the absence of the ground truth image where different identity drives the target face, the following metrics are more relevant. Cosine similarity (CSIM) of embedding vectors generated by pre-trained face recognition model (Deng et al. 2019) is used to evaluate the quality of identity preservation. To inspect the capability of the model to properly reenact the pose and the expression of the driver, we compute PRMSE, the root mean square error of the head pose angles, and AUCON, the ratio of identical facial action unit values, between the generated images and the driving images. OpenFace (Baltrusaitis et al. 2018) is utilized to compute pose angles and action unit values.

Experimental Results

Models were compared under self-reenactment and reenactment of different identities, including a user study. Ablation tests were conducted as well. All experiments were conducted under two different settings: one-shot and few-shot, where one or eight target images were used respectively.

Self-reenactment

FIG. 34 illustrates the evaluation results of the models under self-reenactment settings on VoxCeleb1. MarioNETte surpasses other models in every metric under few-shot setting and outperforms other models in every metric except for PSNR under the one-shot setting. However, MarioNETte shows the best performance in M-PSNR which implies that it performs better on facial region compared to baselines. The low CSIM yielded from NeuralHead-FF is an indirect evidence of the lack of capacity in AdalN-based methods.

Reenacting Different Identity

FIG. 35 displays the evaluation result of reenacting a different identity on CelebV, and FIG. 33 shows generated images from proposed method and baselines. MarioNETte and MarioNETte+LT preserve target identity adequately, thereby outperforming other models in CSIM. The proposed method alleviates the identity preservation problem regardless of the driver being of the same identity or not. While NeuralHead-FF exhibits slightly better performance in terms of PRMSE and AUCON compared to MarioNETte, the low CSIM of NeuralHead-FF portrays the failure to preserve the target identity. The landmark transformer significantly boosts identity preservation at the cost of a slight decrease in PRMSE and AUCON. The decrease may be due to the PCA bases for the expression disentanglement not being diverse enough to span the whole space of expressions. Moreover, the disentanglement of identity and expression itself is a non-trivial problem, especially in a one-shot setting.

User Study

Two types of user studies are conducted to assess the performance of the proposed model:
Comparative analysis. Given three example images of the target and a driver image, we displayed two images generated by different models and asked human evaluators to select an image with higher quality. The users were asked to assess the quality of an image in terms of (1) identity preservation, (2) reenactment of driver's pose and expression, and (3) photo-realism. We report the winning ratio of baseline models compared to our proposed models. We believe that user reported score better reflects the quality of different models than other indirect metrics.
Realism analysis. Similar to the user study protocol of Zakharov et al. (2019), three images of the same person, where two of the photos were taken from a video and the remaining generated by the model, were presented to human evaluators. Users were instructed to choose an image that differs from the other two in terms of the identity under a three-second time limit. We report the ratio of deception, which demonstrates the identity preservation and the photo-realism of each model.

For both studies, 150 examples were sampled from CelebV, which were evenly distributed to 100 different human evaluators.

FIG. 36 illustrates that our models are preferred over existing methods achieving realism scores with a large margin. The result demonstrates the capability of MarioNETte in creating photo-realistic reenactments while preserving the target identity in terms of human perception. We see a slight preference of MarioNETte over MarioNETte+LT, which agrees with the FIG. 35, as MarioNETte+LT has better identity preservation capability at the expense of slight degradation in expression transfer. Since the identity preservation capability of MarioNETte+LT surpasses all other models in realism score, almost twice the score of even MarioNETte on few-shot settings, we consider the minor decline in expression transfer a good compromise.

Ablation Test

We performed ablation test to investigate the effectiveness of the proposed components. While keeping all other things the same, we compare the following configurations reenacting different identities: (1) MarioNETte is the proposed method where both image attention block and target feature alignment are applied. (2) AdaIN corresponds to the same model as MarioNETte, where the image attention block is replaced with AdaIN residual block while the target feature alignment is omitted. (3) +Attention is a MarioNETte where only the image attention block is applied. (4) +Alignment only employs the target feature alignment.

FIG. 37 shows result of ablation test. For identity preservation (i.e., CSIM), AdaIN has a hard time combining style features depending solely on AdaIN residual blocks. +Attention alleviates the problem immensely in both one-shot and few-shot settings by attending to proper coordinates. While +Alignment exhibits a higher CSIM compared to +Attention, it struggles in generating plausible images for unseen poses and expressions leading to worse PRMSE and AUCON. Taking advantage of both attention and target feature alignment, MarioNETte outperforms +Alignment in every metric under consideration.

Entirely relying on target feature alignment for reenactment, +Alignment is vulnerable to failures due to large differences in pose between target and driver that MarioNETte can overcome. Given a single driver image along with three target images (FIG. 38A), +Alignment has defects on the forehead (denoted by arrows in FIG. 38B). This is due to (1) warping low-level features from a large-pose input and (2) aggregating features from multiple targets with diverse poses. MarioNETte, on the other hand, gracefully handles the situation by attending to proper image among several target images as well as adequate spatial coordinates in the target image. The attention map, highlighting the area where the image attention block is focusing on, is illustrated with white in FIG. 38A. Note that MarioNETte attends to the forehead and adequate target images (Target 2 and 3 in FIG. 38A) which has similar pose with driver.

Related Works

The classical approach to face reenactment commonly involves the use of explicit 3D modeling of human faces (Blanza and Vetter 1999) where the 3DMM parameters of the driver and the target are computed from a single image, and blended eventually (Thies et al. 2015; Thies et al. 2016). Image warping is another popular approach where the target image is modified using the estimated flow obtained form 3D models (Cao et al. 2013) or sparse landmarks (Averbuch-Elor et al. 2017). Face reenactment studies have embraced the recent success of neural networks exploring different image-to-image translation architectures (Isola et al. 2017) such as the works of Xu et al. (2017) and that of Wu et al. (2018), which combined the cycle consistency loss (Zhu et al. 2017). A hybrid of two approaches has been studied as well. Kim et al. (2018) trained an image translation network which maps reenacted render of a 3D face model into a photo-realistic output.

Architectures, capable of blending the style information of the target with the spatial information of the driver, have been proposed recently. AdaIN (Huang and Belongie 2017; Huang et al. 2018; Liu et al. 2019) layer, attention mechanism (Zhu et al. 2019; Lathuili'ere et al. 2019; Park and Lee 2019), deformation operation (Siarohin et al. 2018; Dong et al. 2018), and GAN-based method (Bao et al. 2018) have all seen a wide adoption. Similar idea has been applied to few-shot face reenactment settings such as the use of image-level (Wiles, Koepke, and Zisserman 2018) and feature-level (Siarohin et al. 2019) warping, and AdaIN layer in conjuction with a meta-learning (Zakharov et al. 2019). The identity mismatch problem has been studied through methods such as CycleGAN-based landmark transformers (Wu et al. 2018) and landmark swappers (Zhang et al. 2019). While effective, these methods either require an independent model per person or a dataset with image pairs that may be hard to acquire.

### CONCLUSIONS

In this paper, we have proposed a framework for few-shot face reenactment. Our proposed image attention block and target feature alignment, together with the landmark transformer, allow us to handle the identity mismatch caused by using the landmarks of a different person. Proposed method do not need additional fine-tuning phase for identity adaptation, which significantly increases the usefulness of the model when deployed in-the-wild. Our experiments including human evaluation suggest the excellence of the proposed method.

One exciting avenue for future work is to improve the landmark transformer to better handle the landmark disentanglement to make the reenactment even more convincing.

Supplemental Materials

MarioNETte Architecture Details

Architecture Design

Given a driver image x and K target images {yⁱ}, the proposed few-shot face reenactment framework which we call MarioNETte first generates 2D landmark images (i.e. rₓ and {r_{y}ⁱ}_{1=i . . . K}.). We utilize a 3D landmark detector [symbol] : [symbol] ^{h×q×3}→ [symbol] ^{68×3} (Bulat and Tzimiropoulos 2017) to extract facial keypoints which includes information about pose and expression denoted as Iₓ= [symbol] (x) and I_{y}ⁱ= [symbol] (yⁱ), respectively. We further rasterize 3D landmarks to an image by rasterizer R, resulting in rₓ= [symbol] (Iₓ), r_{y}ⁱ= [symbol] (I_{y}ⁱ).

We utilize simple rasterizer that orthogonally projects 3D landmark points, e.g., (x, y, z), into 2D XY-plane, e.g., (x,y), and we group the projected landmarks into 8 categories: left eye, right eye, contour, nose, left eyebrow, right eyebrow, inner mouth, and outer mouth. For each group, lines are drawn between predefined order of points with predefined colors (e.g., red, red, green, blue, yellow, yellow, cyan, and cyan respectively), resulting in a rasterized image as shown in FIG. 39.

MarioNETte Consists of Conditional Image Generator

G(rₓ;{yⁱ}_{i=1 . . . K}, {r_{y}ⁱ}_{i=1 . . . K}) and projection discriminator D(\hat{x}, \hat{r}, c) The discriminator D determines whether the given image \hat{x} is a real image from the data distribution taking into account the conditional input of the rasterized landmarks \hat{r} and identity c.

The generator G(rₓ; {yⁱ}_{i=1 . . . K}, {r_{y}ⁱ}_{i=1 . . . K}) is further broken down into four components: namely, target encoder, drvier encoder, blender, and decoder. Target encoder E_{y}(y, r_{y}) takes target image and generates encoded target feature map z y together with the warped target feature map Ŝ. Driver encoder Eₓ(rₓ) receives a driver image and creates a driver feature map zₓ. Blender B(zₓ, {z_{y}ⁱ}_{i=1 . . . K}) combines encoded feature maps to produce a mixed feature map z_{xy}. Decoder Q(z_{xy}, {Ŝⁱ}_{i=1 . . . K}) generates the reenacted image. Input image y and the landmark image r_{y} are concatenated channel-wise and fed into the target encoder.

The target encoder E_{y}(y, r_{y}) adopts a U-Net (Ronneberger, Fischer, and Brox 2015) style architecture including five downsampling blocks and four upsampling blocks with skip connections. Among five feature maps {sⱼ}_{j=1 . . . 5} generated by the downsampling blocks, the most downsampled feature map, s 5, is used as the encoded target feature map z_{y}, while the others, {sⱼ}_{j=1 . . . 4}, are transformed into normalized feature maps. A normalization flow map f_{y}∈ [symbol] ^{(h/2)×(w/2)×2} transforms each feature map into normalized feature map, S̅={ŝⱼ}_{j=1 . . . 4}, through warping function [symbol] as follows:

Ŝ={ [symbol] (s₁;f_{y}), . . . [symbol] (s₄;f_{y})} [Equation 26]

Flow map f_{y} is generated at the end of upsampling blocks followed by an additional convolution layer and a hyperbolic tangent activation layer, thereby producing a 2-channel feature map, where each channel denotes a flow for the horizontal and vertical direction, respectively.

We adopt bilinear sampler based warping function which is widely used along with neural networks due to its differentiability (Jaderberg et al. 2015; Balakrishnan et al. 2018; Siarohin et al. 2019). Since each s has a different width and height, average pooling is applied to downsample f_{y} to match the size of f_{y} to that of sⱼ.

The driver encoder Eₓ(rₓ), which consists of four residual downsampling blocks, takes driver landmark image rₓ and generates driver feature map zₓ.

The blender B(zₓ,{z_{y}ⁱ}_{i=1 . . . K}) produces mixed feature map z_{xy} by blending the positional information of zₓ with the target style feature maps z_{y}. We stacked three image attention blocks to build our blender.

The decoder Q(z_{xy}{Ŝⁱ}_{i=1 . . . K}) consists of four warp-alignment blocks followed by residual upsampling blocks. Note that the last upsampling block is followed by an additional convolution layer and a hyperbolic tangent activation function.

The discriminator D(\hat{x}, \hat{r}, c) consists of five residual downsampling blocks without self-attention layers. We adopt a projection discriminator with a slight modification of removing the global sum-pooling layer from the original structure. By removing the global sum-pooling layer, discriminator generates scores on multiple patches like PatchGAN discriminator (Isola et al. 2017).

We adopt the residual upsampling and downsampling block proposed by Brock, Donahue, and Simonyan (2019) to build our networks. All batch normalization layers are substituted with instance normalization except for the target encoder and the discriminator, where the normalization layer is absent. We utilized ReLU as an activation function. The number of channels is doubled (or halved) when the output is downsampled (or upsampled). The minimum number of channels is set to 64 and the maximum number of channels is set to 512 for every layer. Note that the input image, which is used as an input for the target encoder, driver encoder, and discriminator, is first projected through a convolutional layer to match the channel size of 64.

Positional Encoding

We utilize a sinusoidal positional encoding introduced by Vaswani et al. (2017) with a slight modification. First, we divide the number of channels of the positional encoding in half. Then, we utilize half of them to encode the horizontal coordinate and the rest of them to encode the vertical coordinate. To encode the relative position, we normalize the absolute coordinate by the width and the height of the feature map. Thus, given a feature map of z∈ [symbol] ^{h}^{_{z}}^{×w}^{_{z}}^{×c}^{_{z}}, the corresponding positional encoding P∈ [symbol] ^{h}^{_{z}}^{×w}^{_{z}}^{×c}^{_{zz}} is computed as follows:

$${P}_{i , j , 4 k} = sin ( \frac{256 i}{{h}_{z} \cdot {10000}^{2 k / {c}_{z}}} ) \\ {P}_{i , j , 4 k + 1} = cos ( \frac{256 i}{{h}_{z} \cdot {10000}^{2 k / {c}_{z}}} ) \\ {P}_{i , j , 4 k + 2} = sin ( \frac{256 j}{{w}_{z} \cdot {10000}^{2 k / {c}_{z}}} ) \\ {P}_{i , j , 4 k + 3} = cos ( \frac{256 j}{{w}_{z} \cdot {10000}^{2 k / {c}_{z}}} ) \qquad [ Equation 27 ]$$

Loss Functions

Our model is trained in an adversarial manner using a projection discriminator D (Miyato and Koyama 2018). The discriminator aims to distinguish between the real image of the identity c and a synthesized image of c generated by G. Since the paired target and the driver images from different identities cannot be acquired without explicit annotation, we trained our model using the target and the driver image extracted from the same video. Thus, identities of x and y are always the same, e.g., c, for every target and driver image pair, i.e., (x, {yⁱ}_{i=1 . . . K}), during the training.

We use hinge GAN loss (Lim and Ye 2017) to optimize discriminator D as follows:

\hat{x}=G(rₓ;{yⁱ},{r_{y}ⁱ})

[symbol]

_{D}=max(0,1−D(x,rₓ,c))+max(0,1+D(\hat{x},rₓ,c)) [Equation 28]

The loss function of the generator consists of four components including the GAN loss [symbol] _{GAN}, the perceptual losses ( [symbol] _{P} and [symbol] _{PF}), and the feature matching loss [symbol] _{FM}. The GAN loss [symbol] _{GAN} is a generator part of the hinge GAN loss and defined as follows:

[symbol]

_{GAN}=−D(\hat{x},rₓ,c) [Equation 29]

The perceptual loss (Johnson, Alahi, and Fei-Fei 2016) is calculated by averaging L₁-distances between the intermediate features of the pre-trained network using ground truth image x and the generated image \hat{x}. We use two different networks for perceptual losses where [symbol] _{P} and [symbol] _{PF} are extracted from VGG19 and VGG-VD-16 each trained for ImageNet classification task (Simonyan and Zisserman 2014) and a face recognition task (Parkhi, Vedaldi, and Zisserman 2015), respectively. We use features from the following layers to compute the perceptual losses: relu1_1, relu2_1, relu3_1, relu4_1, and relu5_1. Feature matching loss [symbol] _{FM} is the sum of L₁-distances between the intermediate features of the discriminator D when processing the ground truth image x and the generated image \hat{x} which helps with the stabilization of the adversarial training. It helps to stabilize the adversarial training. The overall generator loss is the weighted sum of the four losses:

[symbol]

_{G}= [symbol] GAN++λ_{P} [symbol] _{P}+λ_{PF} [symbol] _{PF}+λ_{FM} [symbol] _{FM} [Equation 30]

Training Details

To stabilize the adversarial training, we apply spectral normalization (Miyato et al. 2018) for every layer of the discriminator and the generator. In addition, we use the convex hull of the facial landmarks as a facial region mask and give three-fold weights to the corresponding masked position while computing the perceptual loss. We use Adam optimizer to train our model where the learning rate of 2×10⁻⁴ is used for the discriminator and 5×10⁻⁵ is used for the generator and the style encoder. Unlike the setting of Brock, Donahue, and Simonyan (2019), we only update the discriminator once per every generator updates. We set λ_{P} to 10, λ_{PF} to 0.01, λ_{FM} to 10, and the number of target images K to 4 during the training.

Landmark Transformer Details

Landmark Decomposition

Formally, landmark decomposition is calculated as:

$${\overline{l}}_{m} = \frac{1}{CT} {\sum }_{c} {\sum }_{t} \overline{l} ( c , t ) , \\ {\overline{l}}_{id} ( c ) = \frac{1}{{T}_{c}} {\sum }_{t} \overline{l} ( c , t ) - {\overline{l}}_{m} , \\ \begin{matrix}{\overline{l}}_{exp} ( c , t ) = \overline{l} ( c , t ) - {\overline{l}}_{m} - {\overline{l}}_{id} ( c ) \\ = \overline{l} ( c , t ) - \frac{1}{{T}_{c}} {\sum }_{t} \overline{l} ( c , t ) ,\end{matrix} \qquad [ Equation 31 ]$$

where C is the number of videos, T_{c} is the number of frames of c-th video, and T=ΣT_{c}. We can easily compute the components shown in Equation 31 from the training dataset.

However, when an image of unseen identity c′ is given, the decomposition of the identity and the expression shown in Equation 31 is not possible since Îₑₓₚ(c,t) will be zero for a single image. Even when a few frames of an unseen identity c′ is given, Îₑₓₚ(c′,t) will be zero (or near zero) if the expressions in the given frames are not diverse enough. Thus, to perform the decomposition shown in Equation 31 even under the one-shot or few-shot settings, we introduce landmark disentangler.

Landmark Disentanglement

To compute the expression basis bₑₓₚ, using the expression geometry obtained from the VoxCeleb1 training data, we divide a landmark into different groups (e.g., left eye, right eye, eyebrows, mouth, and any other) and perform PCA on each group. We utilize PCA dimensions of 8, 8, 8, 16 and 8, for each group, resulting in a total number of expression bases, nₑₓₚ, of 48.

We train landmark disentangler on the VoxCeleb1 training set, separately. Before training landmark disentangler, we normalized each expression parameter al to [symbol] follow a standard normal distribution [symbol] (0, 1²) for the ease of regression training. We employ ResNet50, which is pre-trained on ImageNet (He et al. 2016), and extract features from the first layer to the last layer right before the global average pooling layer. Extracted image features are concatenated with the normalized landmark Ī subtracted by the mean landmark m, and fed into a 2-layer MLP followed by a ReLU activation. The whole network is optimized by minimizing the MSE loss between the predicted expression parameters and the target expression parameters, using Adam optimizer with a learning rate of 3×10⁻⁴. We use gradient clipping with the maximum gradient norm of 1 during the training. We set the expression intensity parameter A exp to 1.5.

Additional Ablation Tests

Quantitative Results

In FIG. 34 and FIG. 35 of the main paper, MarioNETte shows better PRMSE and AUCON under the self-reenactment setting on Vox-Celeb1 compared to NeuralHead-FF, which, however, is reversed under the reenactment of a different identity on CelebV. We provide an explanation of this phenomenon through an ablation study.

FIG. 40 illustrates the evaluation results of ablation models under self-reenactment settings on VoxCeleb1. Unlike the evaluation results of reenacting a different identity on CelebV (FIG. 37 of the main paper), +Alignment and MarioNETte show better PRMSE and AUCON compared to the Ada/N. The phenomenon may be attributed to the characteristics of the training dataset as well as the different inductive biases of different models. VoxCeleb1 consists of short video clips (usually 5-10 s long), leading to similar poses and expressions between drivers and targets. Unlike the AdaIN-based model which is unaware of spatial information, the proposed image attention block and the target feature alignment encode spatial information from the target image. We suspect that this may lead to possible overfitting of the proposed model to the same identity pair with a similar pose and expression setting.

Qualitative Results

FIG. 43 and FIG. 44 illustrate the results of ablation models reenacting a different identity on CelebV under the one-shot and few-shot settings, respectively. While AdaIN fails to generate an image that resembles the target identity, +Attention successfully maintains the key characteristics of the target. The target feature alignment module adds fine-grained details to the generated image.

However, MarioNETte tends to generate more natural images in a few-shot setting, while +Alignment struggles to deal with multiple target images with diverse poses and expressions.

Inference Time

In this section, we report the inference time of our model. We measured the latency of the proposed method while generating 256×256 images with different number of target images, K∈{1, 8}. We ran each setting for 300 times and report the average speed. We utilized Nvidia Titan Xp and Pytorch 1.0.1.post2. As mentioned in the main paper, we used the open-sourced implementation of Bulat and Tzimiropoulos (2017) to extract 3D facial landmarks.

FIG. 41 displays the inference time breakdown of our models. Total inference time of the proposed models, MarioNETte+LT and MarioNETte, can be derived as shown in FIG. 42. While generating reenactment videos, z_{y} and Ŝ, utilized to compute the target encoding, is generated only once at the beginning. Thus, we divide our inference pipeline into Target encoding part and the Driver generation part.

Since we perform a batched inference for multiple target images, the inference time of the proposed components (e.g., the target encoder and the target landmark transformer) scale sublinearly to the number of target images K. On the other hand, the open-source 3D landmark detector processes images in a sequential manner, and thus, its processing time scales linearly.

Additional Examples of Generated Images

We provide additional qualitative results of the baseline methods and the proposed models on VoxCeleb1 and CelebV datasets. We report the qualitative results for both one-shot and few-shot (8 target images) settings, except Monkey-Net which is designed for using only a single image. In the case of the few-shot reenactment, we display only one target image, due to the limited space.

FIG. 45 and FIG. 46 compare different methods for the self-reenactment on VoxCeleb1 in one-shot and few-shot settings, respectively. Examples of one-shot and few-shot reenactments on VoxCeleb1 where driver's and target's identity do not match is shown in FIG. 13 and FIG. 48, respectively.

FIG. 49, FIG. 50, and FIG. 51 depict the qualitative results on the CelebV dataset. One-shot and few-shot self-reenactment settings of various methods are compared in FIG. 15 and FIG. 50, respectively. The results of reenacting a different identity on CelebV under the few-shot setting can be found in FIG. 51.

FIG. 52 reveals failure cases generated by MarioNETte+LT while performing a one-shot reenactment under different identity setting on VoxCeleb1. Large pose difference between the driver and the target seems to be the main reason for the failures.

The embodiments described above may also be implemented in the form of a recording medium including instructions executable by a computer, such as a program module executed by a computer. A computer-readable media may be any available media accessible by a computer, and may include both volatile and non-volatile media, separable and non-separable media.

Further, examples of the computer-readable medium may include a computer storage medium. Examples of the computer storage medium include volatile, nonvolatile, separable, and non-separable media realized by an arbitrary method or technology for storing information about a computer-readable instruction, a data structure, a program module, or other data.

At least one of the components, elements, modules or units (collectively “components” in this paragraph) represented by a block in the drawings such as FIGS. 2, 9, 17, 18, 23-27, and 29-32 may be embodied as various numbers of hardware, software and/or firmware structures that execute respective functions described above, according to an exemplary embodiment. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above exemplary embodiments may be implemented in algorithms that execute on one or more processors. Furthermore, the components represented by a block or processing steps may employ any number of related art techniques for electronics configuration, signal processing and/or control, data processing and the like.

While the embodiments of the present disclosure have been particularly shown and described with reference to the attached drawings, it will be understood by those of ordinary skill in the art that various changes in form and details may be made therein without departing from the spirit and scope of the inventive concept as defined by the appended claims. Therefore, the embodiments described above should be considered in a descriptive sense only in all respects and not for purpose of limitation.

1. An image conversion method comprising:
receiving a static image from a user;
obtaining at least one image conversion template; and
converting the static image into a moving image by using the obtained image conversion template.

2. The image conversion method of claim 1,
wherein the moving image includes a plurality of frames.

3. The image conversion method of claim 2,
wherein the plurality of frames include a frame corresponding to the static image.

4. The image conversion method of claim 2,
wherein the moving image has a frame corresponding to the static image, as a first frame, and a frame corresponding to the image conversion template, as a last frame.

5. The image conversion method of claim 1,
wherein the image conversion template is selected by the user from among a plurality of image conversion templates stored in a user terminal of the user.

6. The image conversion method of claim 1,
further comprising receiving at least one reference image from the user,
wherein in the obtaining of the image conversion template, the reference image is obtained as the image conversion template.

7. The image conversion method of claim 6,
wherein the reference image is a captured image of the user or an image of another person selected by the user.

8. The image conversion method of claim 1,
wherein the transforming of the static image into a moving image comprises:
extracting texture information of a face of the user included in the static image;
extracting landmark information of a face of a person included in the image conversion template; and
generating the moving image by combining the texture information and the landmark information.

9. (canceled)

10. An image conversion apparatus comprising:
an image receiver receiving an image from a user;
a template obtainer obtaining at least one image conversion template; and
an image converter transforming the static image into a moving image by using the obtained at least one image conversion template,
wherein the image converter transforms the static image received by the image receiver, into the moving image.

11. The image conversion apparatus of claim 10, wherein the moving image includes a plurality of frames.

12. The image conversion apparatus of claim 11, wherein the plurality of frames include a frame corresponding to the static image.

13. The image conversion apparatus of claim 11, wherein the moving image has a frame corresponding to the static image as a first frame and a frame corresponding to the image conversion template as a last frame.

14. The image conversion apparatus of claim 10, further comprising a template storage storing a plurality of image conversion templates,
wherein the image converter transforms the static image into the moving image by using an image conversion template selected by the user from a plurality of image conversion templates stored in the template storage.

15. The image conversion apparatus of claim 10,
wherein the image receiver receives at least one reference image from the user,
wherein the template obtainer obtains the reference image as the image conversion template.

16. The image conversion apparatus of claim 15,
wherein the reference image is a captured image of the user or an image of another person selected by the user.

17. The image conversion apparatus of claim 10,
wherein the image converter extracts texture information of a face of the user included in the static image;
extracts landmark information of a face of a person included in the image conversion template; and
generates the moving image by combining the texture information and the landmark information.

18. A computer-readable recording medium having embodied thereon a program for executing the method of claim 1.

19. A computer-readable recording medium having embodied thereon a program for executing the method of claim 2.

20. A computer-readable recording medium having embodied thereon a program for executing the method of claim 3.

21. A computer-readable recording medium having embodied thereon a program for executing the method of claim 4.
